(19) United States
(12) Patent Application Publication
(10) Pub. No.: US 2026/0062245 A1
(43) Pub. Date: Mar. 5, 2026

(54) ELECTRODE SHEET TRANSPORTING APPARATUS

(71) Applicant: SAMSUNG SDI CO., LTD., Yongin-si (KR)

(72) Inventors: Sung Won LEE, Suwon-si (KR); Joon Kil KIM, Suwon-si (KR); Sun Uk HWANG, Suwon-si (KR)

(21) Appl. No.: 19/318,755

(22) Filed: Sep. 4, 2025

(30) Foreign Application Priority Data
Sep. 5, 2024 (KR) 10-2024-0120979

(51) Int. Cl. B65H 29/18; B65H 35/00; B65H 43/00; F21V 21/30; G03B 17/56; H04N 23/51

(52) U.S. Cl. CPC B65H 29/18; B65H 35/00; B65H 43/00; F21V 21/30; G03B 17/561; B65H 2301/44322; B65H 2301/515; B65H 2553/42; B65H 2553/46; H04N 23/51

(57) ABSTRACT

An electrode sheet transporting apparatus includes a first transporting conveyor having a supply area receiving an electrode sheet, the first transporting conveyor being configured to transport the electrode sheet in a first direction, a supply member configured to supply the electrode sheet to the supply area, a lighting member configured to radiate light to the supply area, and a sensing member facing the lighting member, the sensing member being configured to detect light reflected from the electrode sheet on the supply area.

### CROSS-REFERENCE TO RELATED APPLICATION

The present application claims priority and the benefit of Korean Patent Application No. 10-2024-0120979, filed on Sep. 5, 2024 in the Korean Intellectual Property Office, the entire disclosure of which is incorporated herein by reference.

### BACKGROUND

### 1 Field

The present disclosure relates to an electrode sheet transporting apparatus.

### 2. Description of the Related Art

Generally, with the recent rapid spread of electronic devices using battery, such as mobile phones, notebook computers, and electric vehicles, the demand for secondary batteries having high energy density and high capacity is rapidly increasing. Therefore, research and development for improving the performance of lithium secondary batteries is actively being conducted.

An electrode assembly of the secondary battery may be formed by a stack process of stacking electrode sheets. A stack manufacturing apparatus performs an operation of cutting an electrode plate material supplied in the form of a reel to form electrode sheets, transporting the formed electrode sheets to a conveyor, and stacking the electrode sheets.

The above-described information disclosed in the technology that forms the background of the present disclosure is only intended to improve understanding of the background of the present disclosure, and thus may include information that does not constitute the related art.

### SUMMARY

Embodiments include an electrode sheet transporting apparatus, including a first transporting conveyor having a supply area receiving an electrode sheet, the first transporting conveyor being configured to transport the electrode sheet in a first direction, a supply member configured to supply the electrode sheet to the supply area, a lighting member configured to radiate light to the supply area, and a sensing member facing the lighting member, the sensing member being configured to detect light reflected from the electrode sheet on the supply area.

The supply member may include a supply conveyor transporting the electrode sheet in a second direction intersecting the first direction, and a conveying unit configured to convey the electrode sheet transported by the supply conveyor to the supply area.

The supply conveyor and the supply area may face each other in the second direction, and the conveying unit may be further configured to reciprocate in the second direction.

The conveying unit may be configured to pass through a space between the lighting member and the sensing member.

The lighting member may include a light source and a lighting bracket supporting the light source.

The lighting bracket may include a first lighting bracket, a second lighting bracket connected to the first lighting bracket to be movable in the first direction, and a third lighting bracket extending from the second lighting bracket, the third lighting bracket being connected to the light source.

The light source may be connected to the third lighting bracket, the light source being rotatable with respect to a second direction intersecting the first direction.

The sensing member may include a camera facing the lighting member in the first direction, and a camera bracket supporting the camera.

The camera bracket may include a first camera bracket, a second camera bracket connected to the first camera bracket, the second camera bracket being movable in the first direction, and a third camera bracket extending from the second camera bracket, the third camera bracket being connected to the camera.

The camera connected to the third camera bracket may be rotatable with respect to a second direction intersecting the first direction.

The electrode sheet transporting apparatus may further include a control member configured to control operation of the supply member based on information detected from the sensing member.

Embodiments include an electrode sheet transporting apparatus, including a first transporting conveyor having a first supply area receiving a first electrode sheet, the first transporting conveyor being configured to transport the first electrode sheet in a first direction, a second transporting conveyor having a second supply area receiving a second electrode sheet, the second transporting conveyor being configured to transport the second electrode sheet in a direction opposite to the first direction, a supply member configured to supply the first electrode sheet and the second electrode sheet to the first supply area and the second supply area, respectively, a lighting member configured to radiate light to the first supply area and the second supply area, and a sensing member facing the lighting member, the sensing member being configured to detect light reflected from the first electrode sheet on the first supply area and light reflected from the second electrode sheet on the second supply area.

The first supply area and the second supply area may be situated in a second direction intersecting the first direction.

The supply member may include a supply conveyor transporting the first electrode sheet and the second electrode sheet in the second direction, and a conveying unit configured to convey the first electrode sheet and the second electrode sheet that are transported by the supply conveyor to the first supply area and the second supply area, respectively.

The lighting member may include a light source, a first lighting bracket spaced apart from the light source, a second lighting bracket connected to the first lighting bracket, the second lighting bracket being movable in the first direction, and a third lighting bracket extending from the second lighting bracket, the third lighting bracket being connected to the light source.

The lighting member may include a first light source radiating light to the first supply area, a second light source spaced apart from the first light source, the second light source radiating light to the second supply area, a first support bracket supporting the first light source, and a second support bracket spaced apart from the first support bracket, the second support bracket supporting the second light source.

The first support bracket may include a first bracket body, a first connection bracket connected to the first bracket body, and a first extension bracket extending from the first connection bracket, the first extension bracket being connected to the first light source, wherein the first light source is connected to the first extension bracket and movable in the second direction.

The first support bracket may include a first bracket body, a first connection bracket connected to the first bracket body, and a first extension bracket extending from the first connection bracket, the first extension bracket being connected to the first light source, wherein the first extension bracket is connected to the first connection bracket and movable in a third direction intersecting the first direction and the second direction.

The first support bracket may include a first bracket body, a first connection bracket connected to the first bracket body, and a first extension bracket extending from the first connection bracket, the first extension bracket being connected to the first light source, wherein the first extension bracket is connected to the first connection bracket, the first extension bracket being rotatable with respect to a third direction intersecting the first direction and the second direction.

The sensing member may include a camera between the first transporting conveyor and the second transporting conveyor, and a camera bracket supporting the camera.

### BRIEF DESCRIPTION OF THE DRAWINGS

Features will become apparent to those of ordinary skill in the art by describing in detail exemplary embodiments with reference to the attached drawings, in which:

FIG. 1 is a schematic plan view showing a configuration of an electrode sheet transporting apparatus according to a first embodiment of the present disclosure;

FIG. 2 is a schematic side view showing the configuration of the electrode sheet transporting apparatus according to the first embodiment of the present disclosure;

FIG. 3 is a schematic perspective view showing a configuration of a lighting member according to the first embodiment of the present disclosure;

FIG. 4 is a schematic side view showing the configuration of the lighting member according to the first embodiment of the present disclosure;

FIG. 5 is a schematic perspective view showing a configuration of a sensing member according to the first embodiment of the present disclosure;

FIG. 6 is a schematic side view showing the configuration of the sensing member according to the first embodiment of the present disclosure;

FIGS. 7 and 8 are views showing a modified example of the sensing members shown in FIGS. 5 and 6;

FIG. 9 is a schematic block diagram showing a configuration of a controller according to the first embodiment of the present disclosure;

FIGS. 10 to 13 are schematic views showing an operation process of the electrode sheet transporting apparatus according to the first embodiment of the present disclosure;

FIG. 14 is a schematic view showing a configuration of an electrode sheet transporting apparatus according to a second embodiment of the present disclosure;

FIG. 15 is a schematic block diagram showing the configuration of the electrode sheet transporting apparatus according to the second embodiment of the present disclosure;

FIG. 16 is a schematic perspective view showing a configuration of a lighting member according to the second embodiment of the present disclosure;

FIG. 17 is a schematic view showing a configuration of a camera according to the second embodiment of the present disclosure;

FIGS. 18 to 21 are schematic views showing an operation process of the electrode sheet transporting apparatus according to the second embodiment of the present disclosure;

FIG. 22 is a schematic view showing a configuration of an electrode sheet transporting apparatus according to a third embodiment of the present disclosure;

FIG. 23 is a schematic perspective view showing a configuration of a lighting member according to the third embodiment of the present disclosure;

FIGS. 24 and 25 are schematic views showing an operation process of the lighting member according to the third embodiment of the present disclosure;

FIG. 26 is a schematic view showing a configuration of a lighting member according to a fourth embodiment of the present disclosure; and

FIG. 27 is a schematic view showing an operation of the lighting member according to the fourth embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

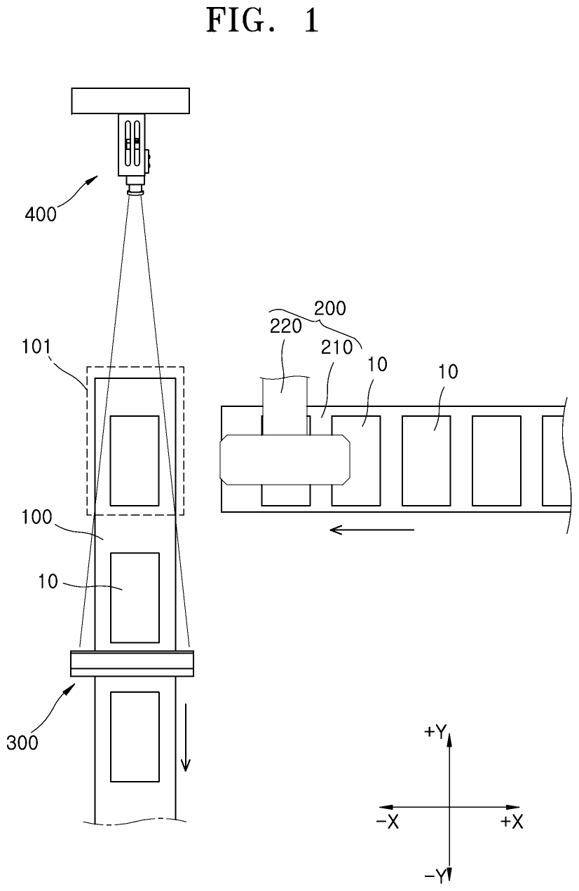

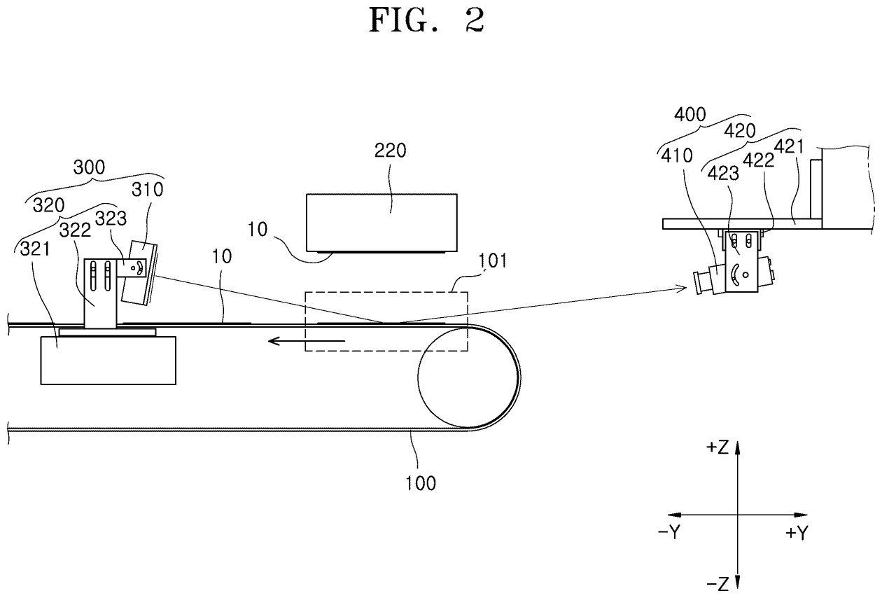

FIG. 1 is a schematic plan view showing a configuration of an electrode sheet transporting apparatus according to a first embodiment of the present disclosure, and FIG. 2 is a schematic side view showing the configuration of the electrode sheet transporting apparatus according to the first embodiment of the present disclosure.

Referring to FIGS. 1 and 2, the electrode sheet transporting apparatus according to the present embodiment may include a transporting conveyor 100, a supply member 200, a lighting member 300, and a sensing member 400.

As described below, a first direction may be exemplified as a −Y-axis direction based on FIGS. 1 and 2, a second direction may be exemplified as a −X-axis direction based on FIGS. 1 and 2, and a third direction may be exemplified as a −Z-axis direction based on FIGS. 1 and 2.

An electrode sheet 10 may function as a unit structure of an electrode assembly that performs charging and discharging operations of a secondary battery. The electrode sheet 10 according to the present embodiment may have a plate shape in which a metal foil such as aluminum or an aluminum alloy is coated with an active material layer. The electrode sheet 10 may function as a negative electrode sheet or a positive electrode sheet of the secondary battery depending on the type of active material included in the active material layer. Although FIG. 1 shows an example of the electrode sheet 10 having a quadrangular shape, the shape of the electrode sheet 10 may be changed in design to any shape such as a circular, an oval shape, etc.

The transporting conveyor 100 may transport the electrode sheet 10 in the first direction.

The transporting conveyor 100 according to the present embodiment may be a typical belt conveyor type in which a belt moves in a caterpillar manner by the rotation of a drive pulley. A belt of the transporting conveyor 100 may be made of a material having a lower reflectivity than the electrode sheet 10. However, the transporting conveyor 100 may be changed in design to any type of transporting unit capable of transporting the electrode sheet 10 in the first direction, such as a roller conveyor, a chain conveyor, etc.

A longitudinal direction of the transporting conveyor 100 may be disposed in the first direction. A plurality of electrode sheets 10 may be arranged on the transporting conveyor 100 at set intervals in the first direction. The transporting conveyor 100 may continuously transport the plurality of electrode sheets 10 in the first direction by the movement of the belt.

The transporting conveyor 100 may include a supply area 101 that receives the electrode sheet 10 from the supply member 200.

The supply area 101 according to the present embodiment may be an area of one end portion of the transporting conveyor 100 at which the transport of the electrode sheet 10 starts among the entire area of the transporting conveyor 100. The electrode sheet 10 supplied from the supply member 200 may be seated on the supply area 101. The electrode sheet 10 seated on the supply area 101 may be transported in the first direction by the operation of the transporting conveyor 100.

The supply member 200 may supply the electrode sheet to the supply area 101 of the transporting conveyor 100.

The supply member 200 according to the present embodiment may include a supply conveyor 210 and a conveying unit 220.

The supply conveyor 210 may transport the electrode sheet 10 in the second direction.

The supply conveyor 210 according to the present embodiment may be a typical belt conveyor type in which a belt moves in a caterpillar manner by the rotation of a drive pulley. However, the supply conveyor 210 may be changed in design to any type of transporting unit capable of transporting the electrode sheet 10 in the second direction, such as a roller conveyor, a chain conveyor, etc.

The supply conveyor 210 may be disposed to intersect the transporting conveyor 100. A longitudinal direction of the supply conveyor 210 may be disposed in the second direction. A plurality of electrode sheets 10 may be arranged on the supply conveyor 210 at set intervals in the second direction. The supply conveyor 210 may continuously transport the plurality of electrode sheets 10 in the second direction by the movement of the belt.

An end portion of the supply conveyor 210 may be disposed to face the supply area 101 of the transporting conveyor 100 in the second direction. The end portion of the supply conveyor 210 may be spaced a predetermined distance from the supply area 101 of the transporting conveyor 100 in a direction opposite to the second direction (the +X-axis direction).

The conveying unit 220 may convey the electrode sheet 10 transported by the supply conveyor 210 to the supply area 101.

The conveying unit 220 according to the present embodiment may be disposed at a position spaced apart from the supply conveyor 210 and the transporting conveyor 100 in a direction opposite to the third direction (the +Z-axis direction), for example, above the supply conveyor 210 and the transporting conveyor 100.

The conveying unit 220 may reciprocate between the supply conveyor 210 and the transporting conveyor 100. For example, the conveying unit 220 may repeatedly perform an operation of moving in the second direction from the supply conveyor 210 to the transporting conveyor 100 and then moving in the direction opposite to the second direction from the transporting conveyor 100 to the supply conveyor 210.

The conveying unit 220 may move in the third direction and in the direction opposite to the third direction (+Z-axis direction) on the supply conveyor 210 and pick up the electrode sheet 10. For example, the conveying unit 220 may include an adsorber for adsorbing the electrode sheet 10 by a vacuum pressure or a gripper for gripping the electrode sheet 10 by a gripping operation.

The conveying unit 220 may move toward the electrode sheet 10 in the third direction on the supply conveyor 210 and come into contact with the electrode sheet 10. The electrode sheet 10 may be fixed to the conveying unit 220 by an adsorbing or gripping method. Then, the conveying unit 220 may move from the supply conveyor 210 in the direction opposite to the third direction and move toward the transporting conveyor 100 in the second direction.

After the conveying unit 220 moves from the supply conveyor 210 in the second direction, the conveying unit 220 may move in the third direction and in the direction opposite to the third direction on the transporting conveyor 100 and allow the electrode sheet 10 to be seated on the supply area 101.

For example, the conveying unit 220 may move toward the supply area 101 in the third direction on the transporting conveyor 100 and allow the electrode sheet 10 to be seated on the supply area 101 by a method of releasing the adsorption of the electrode sheet 10 by the adsorber or releasing the grip of the electrode sheet 10 by the gripper. Then, the conveying unit 220 may move from the transporting conveyor 100 in the direction opposite to the third direction and move toward the supply conveyor 210 in the direction opposite to the second direction.

The lighting member 300 may radiate light to the supply area 101.

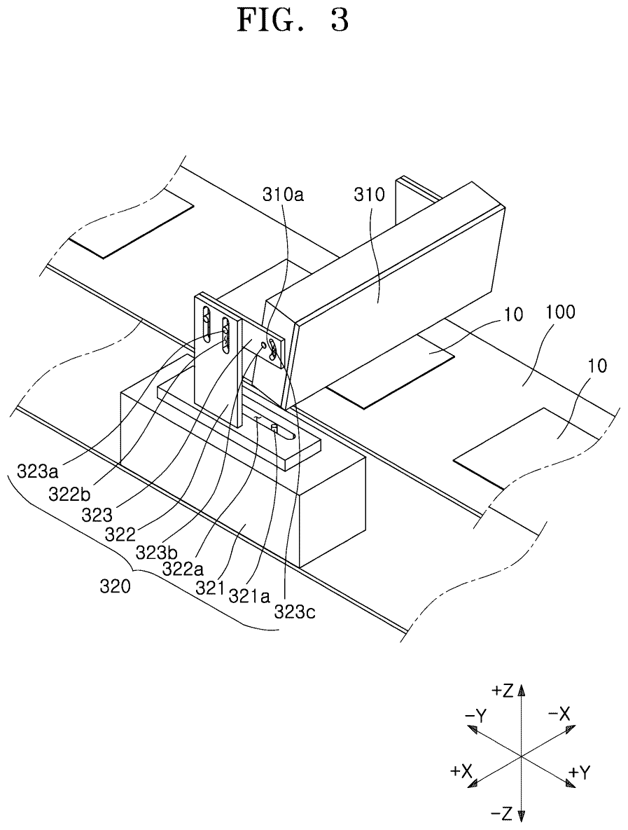

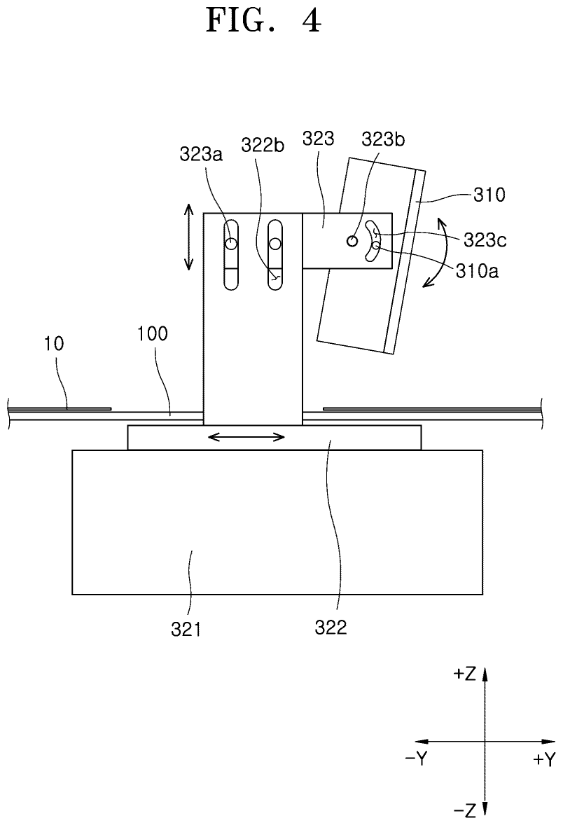

FIG. 3 is a schematic perspective view showing a configuration of a lighting member 300 according to the first embodiment of the present disclosure, and FIG. 4 is a schematic side view showing the configuration of the lighting member according to the first embodiment of the present disclosure.

Referring to FIGS. 1 to 4, the lighting member 300 may include a light source 310 and a lighting bracket 320.

The light source 310 may be spaced apart from the transporting conveyor 100 and may radiate light toward the supply area 101.

The light source 310 according to the present embodiment may be disposed at an upper side of the transporting conveyor 100. The light source 310 may be disposed at a position spaced a predetermined distance from the supply area 101 in the first direction.

The light source 310 may include a case having a substantially rectangular box shape and any type of light-emitting device, such as a light emitting diode (LED), a fluorescent lamp, an incandescent lamp, a halogen lamp, or a laser, disposed inside the case. Light generated from the light-emitting device may be radiated to the supply area 101 through one surface of the light source 310 disposed to face the supply area 101.

A width of the light source 310 in the second direction may be greater than a width of the transporting conveyor 100 in the second direction. Therefore, the light source 310 may radiate light over the overall width of the supply area 101.

The lighting bracket 320 may support the light source 310.

The lighting bracket 320 according to the present embodiment may include a first lighting bracket 321, a second lighting bracket 322, and a third lighting bracket 323.

The first lighting bracket 321 may form the exterior of one side of the lighting bracket 320 and support the second lighting bracket 322.

A pair of first lighting brackets 321 according to the present embodiment may be provided. The pair of first lighting brackets 321 may be disposed to face each other in the second direction with the transporting conveyor 100 interposed therebetween. The first lighting bracket 321 may be fixed to a frame of the transporting conveyor 100 or otherwise may be fixed on the ground. The shape of the first lighting bracket 321 shown in FIGS. 3 and 4 may be changed in design in various ways within the technical spirit of the shape capable of supporting the second lighting bracket 322 that will be described below.

The second lighting bracket 322 may be connected to the first lighting bracket 321 to support the third lighting bracket 323.

The second lighting bracket 322 according to the present embodiment may have a form in which a lower side is seated on the first lighting bracket 321 and an upper side extends upward from the first lighting bracket 321, that is, in the direction opposite to the third direction (the +Z-axis direction). A height of an upper end portion of the second lighting bracket 322 may be greater than a height of the electrode sheet 10 seated on the transporting conveyor 100. Therefore, the second lighting bracket 322 can prevent interference between the light source 310 and the electrode sheet 10.

A pair of second lighting brackets 322 may be provided. The pair of second lighting brackets 322 may be individually connected to different first lighting brackets 321.

The second lighting bracket 322 may be connected to the first lighting bracket 321 to be movable in the first direction (−Y-axis direction) and in the direction opposite to the first direction (+Y-axis direction). Therefore, the second lighting bracket 322 may adjust a space between the light source 310 and the sensing member 400 according to a size of the electrode sheet 10, a position of the sensing member 400, and the like, which will be described below.

For example, the lighting member 300 may further include a first lighting rail 322a passing through the second lighting bracket 322. The first lighting rail 322a according to the present embodiment may pass through a lower portion of the second lighting bracket 322 seated on the first lighting bracket 321 in the third direction. A longitudinal direction of the first lighting rail 322a may extend in the first direction.

The lighting member 300 may further include a first lighting pin 321a protruding from the first lighting bracket 321 and inserted into the first lighting rail 322a. The first lighting pin 321a according to the present embodiment may have a rod shape that extends from an upper surface of the first lighting bracket 321 on which the second lighting bracket 322 is seated in the direction opposite to the third direction.

The second lighting bracket 322 may slide in the first direction or in the direction opposite to the first direction by an external force applied from the outside in a state in which the first lighting pin 321a is inserted into the first lighting rail 322a.

However, the connection relationship between the first lighting bracket 321 and the second lighting bracket 322 may be changed in design in various ways within the range of a structure in which the first lighting bracket 321 may move relative to the second lighting bracket 322 in the first direction.

The third lighting bracket 323 may extend from the second lighting bracket 322 and support the light source 310.

The third lighting bracket 323 according to the present embodiment may have a plate shape that extends from the upper end portion of the second lighting bracket 322 in the direction opposite to the first direction (+Y-axis direction). One end portion of the third lighting bracket 323 may be disposed to face the upper end portion of the second lighting bracket 322 in the second direction. The other end portion of the third lighting bracket 323 may protrude outward from the second lighting bracket 322 and may be disposed to face a side surface of the light source 310 in the second direction.

A pair of third lighting brackets 323 may be provided. The pair of third lighting brackets 323 may be individually connected to different second lighting brackets 322.

The third lighting bracket 323 may be connected to the second lighting bracket 322 to be movable in the third direction or in the direction opposite to the third direction. Therefore, the third lighting bracket 323 may adjust the height of the light source 310 in response to a difference in height between the conveying unit 220 and the supply area 101 when the electrode sheet 10 is supplied.

For example, the lighting member 300 may further include a second lighting rail 322b passing through the second lighting bracket 322. The second lighting rail 322b according to the present embodiment may pass through an upper end portion of the second lighting bracket 322 facing the third lighting bracket 323 in the second direction. A longitudinal direction of the second lighting rail 322b may extend in the third direction.

The lighting member 300 may further include a second lighting pin 323a protruding from the third lighting bracket 323 and inserted into the second lighting rail 322b. The second lighting pin 323a according to the present embodiment may have a rod shape that extends from one end portion of the third lighting bracket 323 facing the second lighting bracket 322 in the direction parallel to the second direction.

The third lighting bracket 323 may slide in the third direction (−Z-axis direction) or in the direction opposite to the third direction (+Z-axis direction) by an external force applied from the outside in a state in which the second lighting pin 323a is inserted into the second lighting rail 322b.

However, the connection relationship between the second lighting bracket 322 and the third lighting bracket 323 may be changed in design in various ways within the range of a structure in which the third lighting bracket 323 may move relatively with respect to the second lighting bracket 322 in the third direction.

The light source 310 may be connected to the third lighting bracket 323 to be rotatable with respect to the second direction. Therefore, an angle of light radiated from the light source 310 may be adjusted according to the position of the sensing member 400, the height of the electrode sheet 10, or the like.

For example, the lighting member 300 may further include a light source shaft 323b for rotatably supporting the light source 310 with respect to the third lighting bracket 323. The light source shaft 323b according to the present embodiment may have a pin shape that passes through the other end portion of the third lighting bracket 323 facing the light source 310 and the side surface of the light source 310. A longitudinal direction of the light source shaft 323b may be disposed in the second direction. The light source 310 may be rotated about the light source shaft 323b clockwise or counterclockwise by an external force applied from the outside.

The lighting member 300 may further include a third lighting rail 323c and a third lighting pin 310a that guide the rotation of the light source 310 with respect to the third lighting bracket 323.

The third lighting rail 323c according to the present embodiment may pass through the other end portion of the third lighting bracket 323 facing the side surface of the light source 310 in the second direction. The third lighting rail 323c may have an arc shape that extends in a circumferential direction based on the light source shaft 323b.

The third lighting pin 310a according to the present embodiment may have a rod shape that extends from the side surface of the light source 310 facing the third lighting bracket 323 in the direction parallel to the second direction. The third lighting pin 310a may be inserted into the third lighting rail 323c. As the light source 310 rotates about the light source shaft 323b, the third lighting pin 310a may slide along the third lighting rail 323c.

However, the connection relationship between the third lighting bracket 323 and the light source 310 may be changed in design in various ways within the range of a structure in which the light source 310 is connected to the third lighting bracket 323 to be rotatable with respect to the second direction.

The lighting member 300 according to the present embodiment may further include an actuator, such as a motor, and a power transmission unit, such as a reducer, to move or rotate the light source 310, the second lighting bracket 322, and the third lighting bracket 323 by their own driving force.

The sensing member 400 may be disposed to face the lighting member 300 (see FIG. 2). The sensing member 400 may detect the presence or absence of the electrode sheet 10 on the supply area 101 based on the light radiated from the lighting member 300.

For example, the sensing member 400 may detect light reflected from the electrode sheet 10 positioned in the supply area 101. Since the electrode sheet 10 is made of a metallic material, the amount of light reflected from the electrode sheet 10 may be greater than the amount of light reflected from the belt of the transporting conveyor 100. The sensing member 400 may detect the presence or absence of the electrode sheet 10 on the supply area 101 through a difference in reflectivity between the electrode sheet 10 and the transporting conveyor 100.

The sensing member 400 and the lighting member 300 may be spaced apart from each other in the first direction. For example, the sensing member 400 may be disposed at a position spaced a predetermined distance from the lighting member 300 in the direction opposite to the first direction. Therefore, the conveying unit 220 moving in the second direction or in the direction opposite to the second direction between the supply conveyor 210 and the transporting conveyor 100 may smoothly pass through a space between the lighting member 300 and the sensing member 400 without interfering with the lighting member 300 and the sensing member 400.

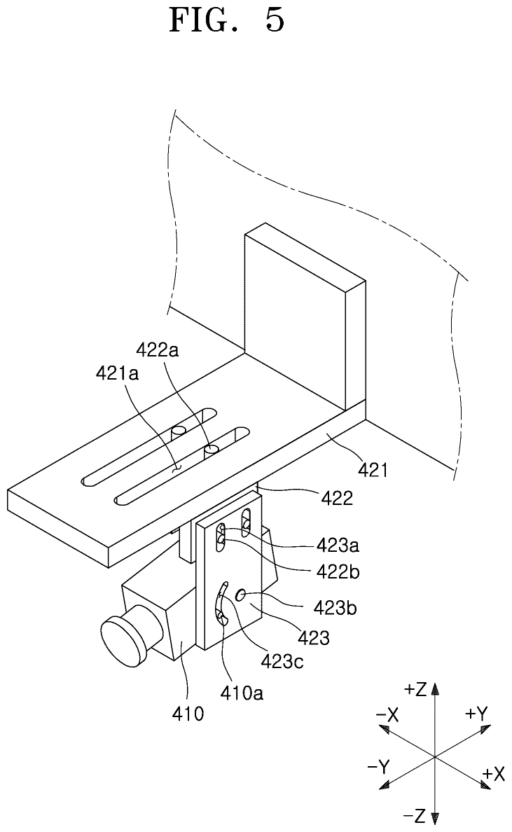

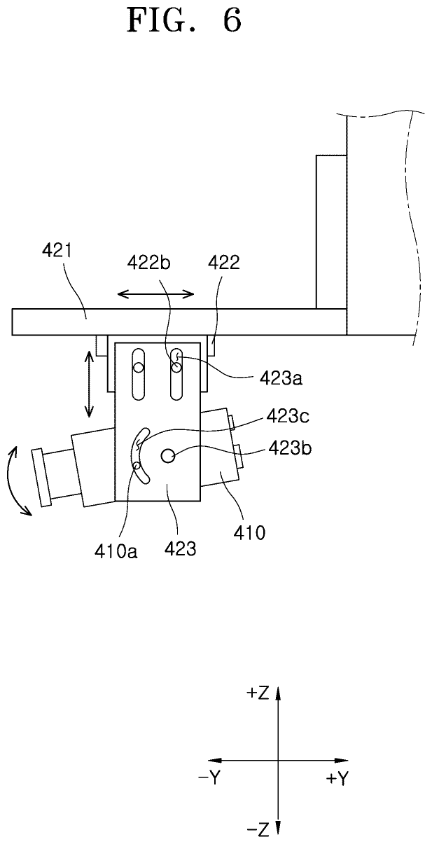

FIG. 5 is a schematic perspective view showing a configuration of a sensing member according to the first embodiment of the present disclosure, and FIG. 6 is a schematic side view showing the configuration of the sensing member according to the first embodiment of the present disclosure.

Referring to FIGS. 5 and 6, the sensing member 400 according to the present embodiment may include a camera 410 and a camera bracket 420.

The camera 410 may acquire an optical image of the supply area 101.

The camera 410 according to the present embodiment may be exemplified as any type of optical device capable of detecting the light reflected from the electrode sheet 10 positioned in the supply area 101, such as a mono camera, a color camera, or a vision sensor.

The camera 410 may be disposed to face the lighting member 300, more specifically, the light source 310 in the first direction. The camera 410 may be disposed to face the light source 310 in the first direction with the supply area 101 interposed therebetween. The camera 410 may be disposed at a position spaced a predetermined distance from the lighting member 300 in the direction opposite to the first direction. The camera 410 may be disposed above the transporting conveyor 100. The camera 410 may be disposed so as not to face the transporting conveyor 100 in the third direction or otherwise may be disposed to face the transporting conveyor 100 in the third direction. The camera 410 may be disposed so that a lens faces the supply area 101 and the light reflected from the electrode sheet 10 is incident on the supply area 101.

The camera bracket 420 may support the camera 410.

The camera bracket 420 according to the present embodiment may include a first camera bracket 421, a second camera bracket 422, and a third camera bracket 423.

The first camera bracket 421 may form the exterior of one side of the camera bracket 420 and support the second camera bracket 422.

The first camera bracket 421 according to the present embodiment may be spaced apart from the transporting conveyor 100. The first camera bracket 421 may be disposed above the transporting conveyor 100. The first camera bracket 421 may be fixed to a wall, ceiling, or separate frame and fixedly positioned above the transporting conveyor 100. The first camera bracket 421 may be disposed so as not to face the transporting conveyor 100 in the third direction or otherwise may be disposed to face the transporting conveyor 100 in the third direction. The shape of the first camera bracket 421 as shown in FIGS. 5 and 6 may be changed in design in various ways within the technical spirit of the shape capable of supporting the second camera bracket 422 that will be described below.

The second camera bracket 422 may be connected to the first camera bracket 421 to support the third camera bracket 423.

The second camera bracket 422 according to the present embodiment may be disposed under the first camera bracket 421 (in the −Z-axis direction). The shape of the second camera bracket 422 shown in FIGS. 5 and 6 may be changed in design in various ways within the technical spirit of the shape capable of supporting the third camera bracket 423 that will be described below.

The second camera bracket 422 may be connected to the first camera bracket 421 to be movable in the first direction and in the direction opposite to the first direction. Therefore, the second camera bracket 422 may adjust a space between the light source 310 and the camera 410 according to the size of the electrode sheet 10, the position of the lighting member 300, and the like.

For example, the sensing member 400 may further include a first camera rail 421a passing through the first camera bracket 421. The first camera rail 421a according to the present embodiment may pass through the first camera bracket 421 in the third direction. A longitudinal direction of the first camera rail 421a may extend in the first direction.

The sensing member 400 may further include a first camera pin 422a protruding from the second camera bracket 422 and inserted into the first camera rail 421a. The first camera pin 422a according to the present embodiment may have a rod shape that extends from an upper surface of the second camera bracket 422 facing the first camera bracket 421 in the direction opposite to the third direction.

The second camera bracket 422 may slide in the first direction or in the direction opposite to the first direction by an external force applied from the outside in a state in which the first camera pin 422a is inserted into the first camera rail 421a.

However, the connection relationship between the first camera bracket 421 and the second camera bracket 422 may be changed in design in various ways within the range of a structure in which the second camera bracket 422 may move relatively with respect to the first camera bracket 421 in the first direction.

The third camera bracket 423 may extend from the second camera bracket 422 and support the camera 410.

The third camera bracket 423 according to the present embodiment may have a plate shape that extends from a lower end portion of the second camera bracket 422 in the third direction. An upper end portion of the third camera bracket 423 may be disposed to face the lower end portion of the second camera bracket 422 in the second direction. A lower end portion of the third camera bracket 423 may protrude outward from the second camera bracket 422 and may be disposed to face a side surface of the camera 410 in the second direction.

The third camera bracket 423 may be connected to the second camera bracket 422 to be movable in the third direction and in the direction opposite to the third direction. Therefore, the third camera bracket 423 may adjust the height of the camera 410 in response to a difference in height between the conveying unit 220 and the supply area 101 when the electrode sheet 10 is supplied.

For example, the sensing member 400 may further include a second camera rail 423a passing through the third camera bracket 423. The second camera rail 423a according to the present embodiment may pass through the upper end portion of the third camera bracket 423 facing the lower end portion of the second camera bracket 422 in the second direction. A longitudinal direction of the second camera rail 423a may extend in the third direction.

The sensing member 400 may further include a second camera pin 422b protruding from the second camera bracket 422 and inserted into the second camera rail 423a. The second camera pin 422b according to the present embodiment may have a rod shape that extends from the lower end portion of the second camera bracket 422 facing the upper end portion of the third camera bracket 423 in the direction parallel to the second direction.

The third camera bracket 423 may slide in the third direction or in the direction opposite to the third direction by an external force applied from the outside in a state in which the second camera pin 422b is inserted into the second camera rail 423a.

However, the connection relationship between the second camera bracket 422 and the third camera bracket 423 may be changed in design in various ways within the range of a structure in which the third camera bracket 423 may move relatively with respect to the second camera bracket 422 in the third direction.

The camera 410 may be connected to the third camera bracket 423 to be rotatable with respect to the second direction. Therefore, a capturing angle of the camera 410 may be adjusted according to the angle of light radiated from the light source 310, the height of the electrode sheet 10, or the like.

For example, the sensing member 400 may further include a camera shaft 423b for rotatably supporting the camera 410 with respect to the third camera bracket 423. The camera shaft 423b according to the present embodiment may have a pin shape that passes through the other end portion of the third camera bracket 423 facing the camera 410 and the side surface of the camera 410. A longitudinal direction of the camera shaft 423b may be disposed in the second direction. The camera 410 may be rotated about the camera shaft 423b clockwise or counterclockwise by an external force applied from the outside.

The sensing member 400 may further include a third camera rail 423c and a third camera pin 410a that guide the rotation of the camera 410 with respect to the third camera bracket 423.

The third camera rail 423c according to the present embodiment may pass through the other end portion of the third camera bracket 423 facing the side surface of the camera 410 in the second direction. The third camera rail 423c may have an arc shape that extends in a circumferential direction based on the camera shaft 423b.

The third camera pin 410a according to the present embodiment may have a rod shape that extends from the side surface of the camera 410 facing the third camera bracket 423 in the direction parallel to the second direction. The third camera pin 410a may be inserted into the third camera rail 423c. As the camera 410 rotates about the camera shaft 423b, the third camera pin 410a may slide along the third camera rail 423c.

However, the connection relationship between the third camera bracket 423 and the camera 410 may be changed in design in various ways within the range of a structure in which the camera 410 is connected to the third camera bracket 423 to be rotatable with respect to the second direction.

The sensing member 400 according to the present embodiment may further include an actuator such as a motor and a power transmission unit such as a reducer to move or rotate the camera 410, the second camera bracket 422, and the third camera bracket 423 by their own driving force.

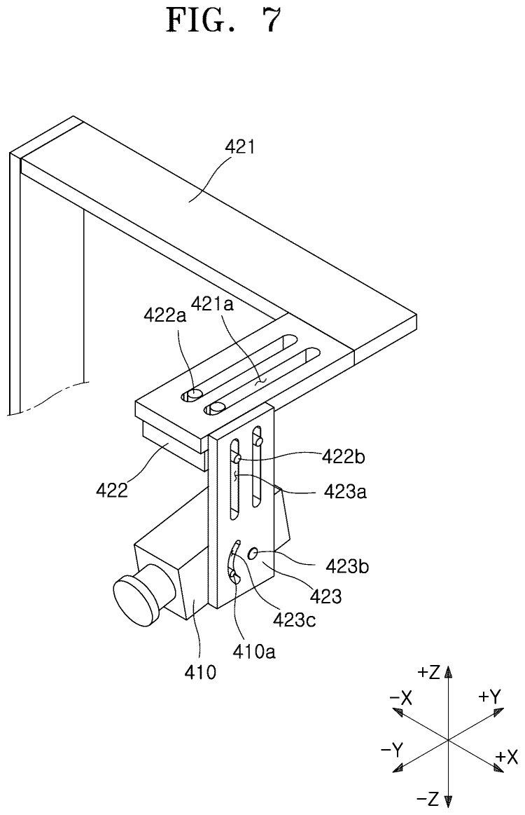

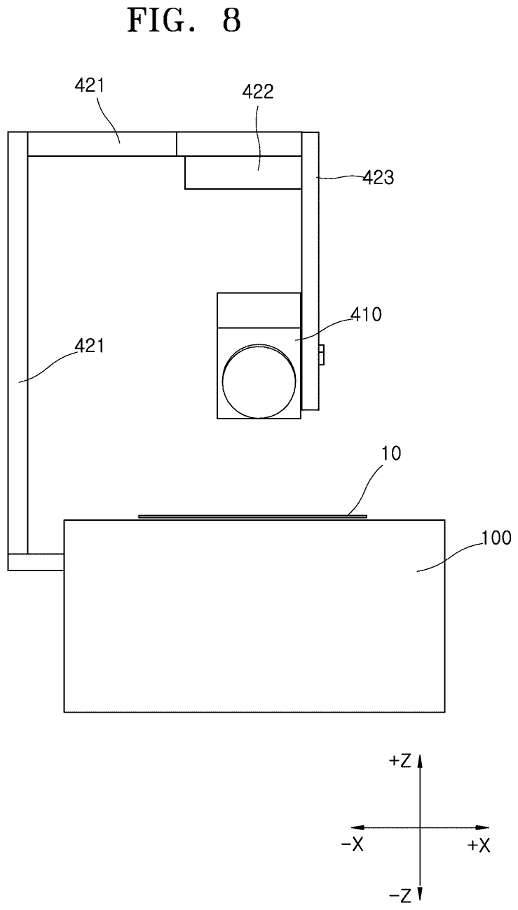

FIGS. 7 and 8 are views showing a modified example of the sensing members shown in FIGS. 5 and 6.

Referring to FIGS. 7 and 8, the first camera bracket 421 may be connected to the transporting conveyor 100. More specifically, a lower end portion of the first camera bracket 421 may be fixed to the frame of the transporting conveyor 100. An upper end portion of the first camera bracket 421 may extend upward from the transporting conveyor 100. The upper end portion of the first camera bracket 421 may support the second camera bracket 422 at a position spaced apart from the lighting member 300 in the direction opposite to the first direction (the +Y-axis direction).

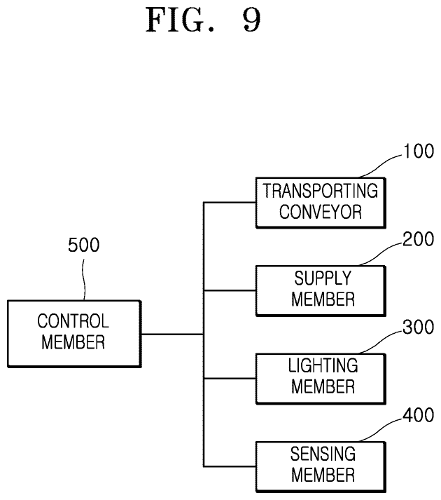

FIG. 9 is a schematic block diagram showing a configuration of a controller according to the first embodiment of the present disclosure.

Referring to FIG. 9, the electrode sheet transporting apparatus according to the present embodiment may further include a control member 500.

The control member 500 may control the overall operation of the transporting conveyor 100, the supply member 200, the lighting member 300, and the sensing member 400.

The control member 500 may control the supply operation of the supply member 200 based on information detected from the sensing member 400. More specifically, the control member 500 may determine the presence or absence of the electrode sheet 10 on the supply area 101 based on the information detected from the sensing member 400. When the control member 500 determines that the electrode sheet 10 is not present on the supply area 101, the control member 500 may operate the supply member 200. When the control member 500 determines that the electrode sheet 10 is present on the supply area 101, the control member 500 may stop the operation of the supply member 200. Therefore, the control member 500 can prevent two or more electrode sheets 10 from overlapping at the same position on the transporting conveyor 100.

In addition, the control member 500 may control the operation of a drive pulley of the transporting conveyor 100 to adjust a transporting speed of the electrode sheet 10, a transporting direction of the electrode sheet 10, whether the electrode sheet 10 is transported, and the like.

In addition, the control member 500 may control the operations of the actuators of the lighting member 300 and the sensing member 400 to adjust the positions, angles, and the like of the light source 310 and the camera 410.

The control member 500 may include at least one of an electronic control unit (ECU), a central processing unit (CPU), a processor, or a system on chip (SoC), control a plurality of hardware or software components by driving an operating system or an application, and perform various data processing and calculations. The control member 500 may be configured to execute at least one command stored in a memory and store execution result data in the memory. The control member 500 may include at least one of a radio frequency (RF), a Wi-Fi, a Bluetooth, a Zigbee, and a near field communication (NFC) device that may implement various communication protocols capable of receiving input signals generated from various input devices.

Hereinafter, the operation of the electrode sheet transporting apparatus according to the first embodiment of the present disclosure will be described.

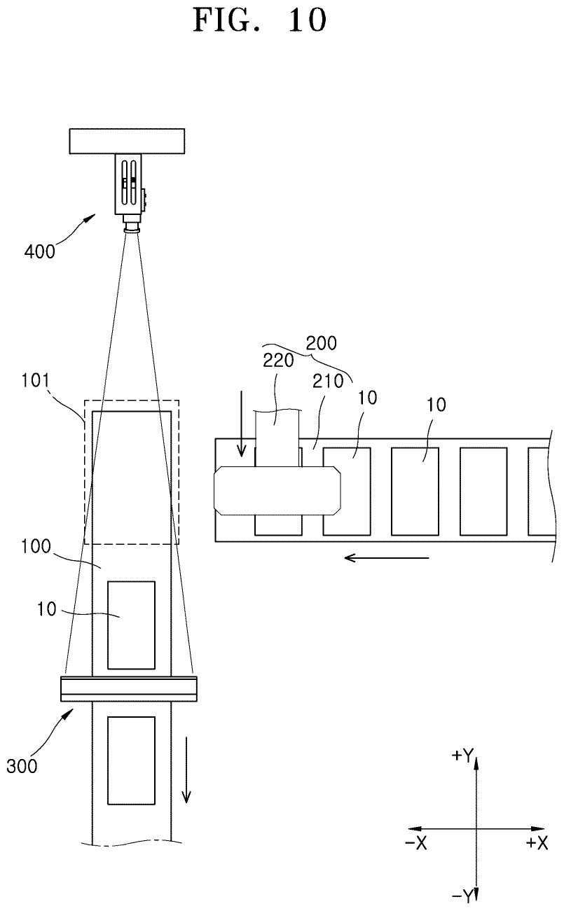

FIGS. 10 to 13 are schematic views showing an operation process of the electrode sheet transporting apparatus according to the first embodiment of the present disclosure.

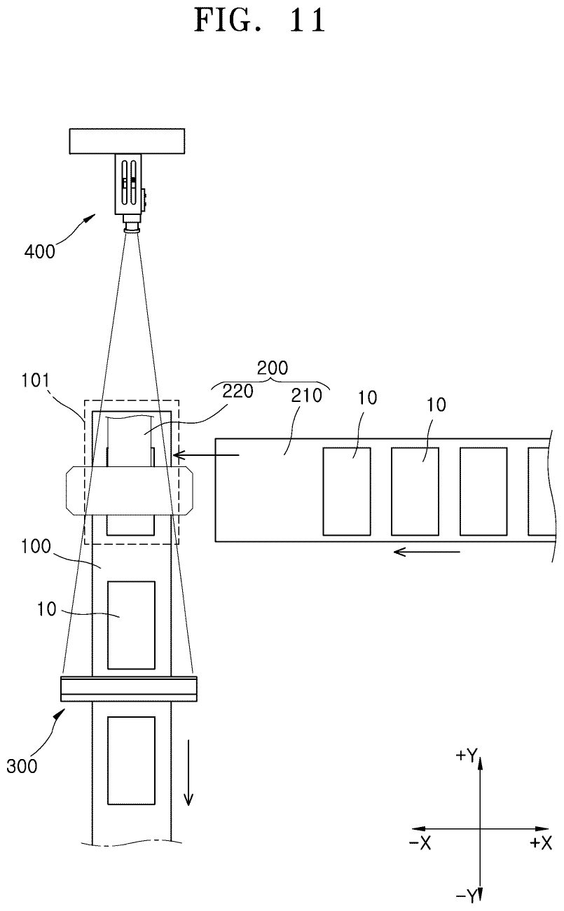

Referring to FIGS. 10 and 11, in a process in which the transporting conveyor 100 transports the electrode sheet 10 in the first direction, the light source 310 radiates light to the supply area 101, and the camera 410 detects light reflected from the supply area 101.

The control member 500 determines whether the electrode sheet 10 is present on the supply area 101 based on the information detected from the sensing member 400.

When the transporting conveyor 100 operates, the electrode sheet 10 positioned on the supply area 101 moves from the supply area 101 in the first direction, and the electrode sheet 10 is not present on the supply area 101.

When the electrode sheet 10 is not present on the supply area 101, the light radiated from the light source 310 to the supply area 101 is not reflected from the supply area 101 or is reflected with the same reflectivity over the entire area of the supply area 101.

Therefore, light is not incident on the camera 410 or light of the same brightness is incident on the entire area of the supply area 101, and the control member 500 determines that the electrode sheet 10 is not present on the supply area 101.

Then, the control member 500 operates the supply member 200 so that the electrode sheet 10 is supplied to the supply area 101.

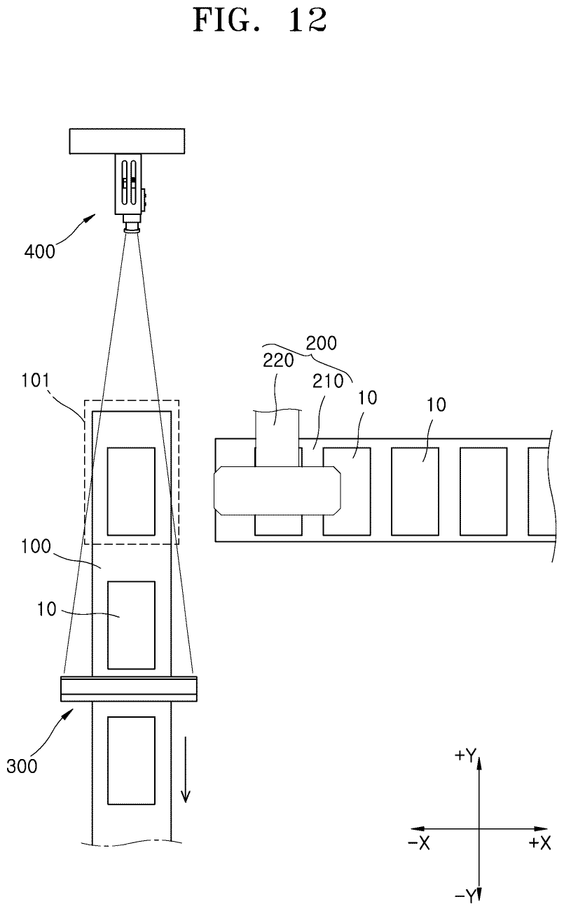

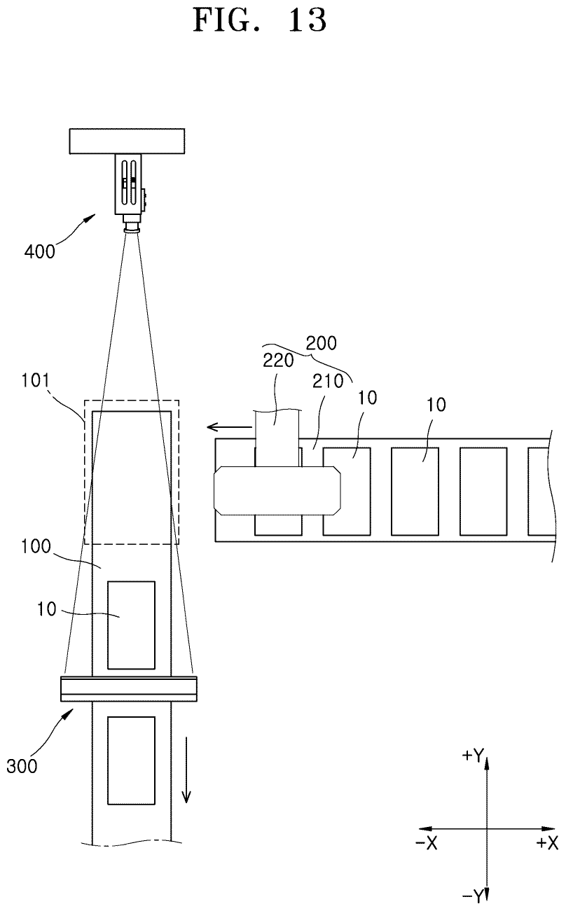

Referring to FIGS. 12 and 13, when an operation error of the transporting conveyor 100 occurs, the electrode sheet 10 positioned on the supply area 101 does not move in the first direction, and the electrode sheet 10 is present on the supply area 101.

As the electrode sheet 10 is made of a material having a higher reflectivity than the belt of the transporting conveyor 100, the brightness of the light reflected from the electrode sheet 10 is greater than the brightness of the light reflected from the belt of the transporting conveyor 100.

Therefore, light of different brightness is incident on the camera 410 in the area in which the electrode sheet 10 is positioned and in the area in which the electrode sheet 10 is not positioned, and the control member 500 determines that the electrode sheet 10 is present on the supply area 101.

Then, the control member 500 stops the operation of the supply member 200 so that the electrode sheet 10 is not supplied to the supply area 101.

Hereinafter, an electrode sheet transporting apparatus according to a second embodiment of the present disclosure will be described.

In describing the electrode sheet transporting apparatus according to the present embodiment, overlapping descriptions of the electrode sheet transporting apparatus according to the first embodiment of the present disclosure will be omitted.

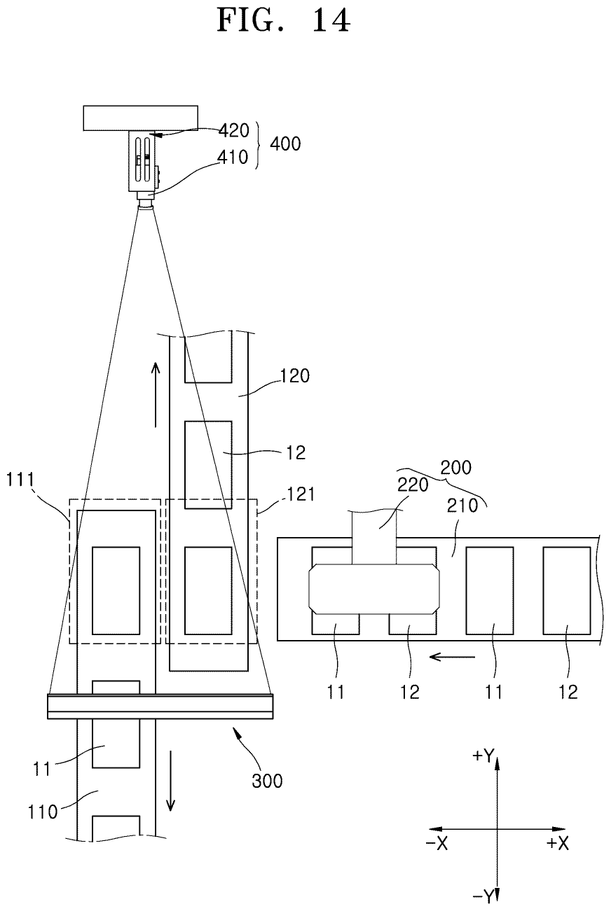

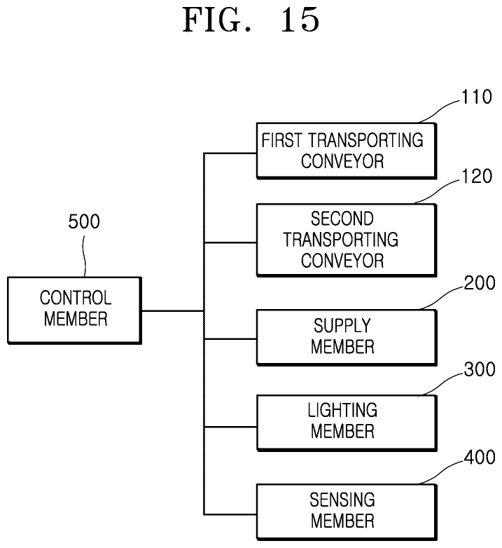

FIG. 14 is a schematic view showing a configuration of an electrode sheet transporting apparatus according to a second embodiment of the present disclosure, and FIG. 15 is a schematic block diagram showing the configuration of the electrode sheet transporting apparatus according to the second embodiment of the present disclosure.

Referring to FIGS. 14 and 15, the electrode sheet transporting apparatus according to the present embodiment may include a first transporting conveyor 110, a second transporting conveyor 120, the supply member 200, the lighting member 300, the sensing member 400, and the control member 500.

The first transporting conveyor 110 and the second transporting conveyor 120 may transport a first electrode sheet 11 and a second electrode sheet 12, respectively.

The first electrode sheet 11 and the second electrode sheet 12 may be electrode sheets having different polarities of an electrode assembly of a secondary battery or otherwise may be electrode sheets having the same polarity. The first electrode sheet 11 and the second electrode sheet 12 may be formed to have the same shape.

The first transporting conveyor 110 may transport the first electrode sheet 11 in the first direction.

The first transporting conveyor 110 according to the present embodiment may be a typical belt conveyor type in which a belt moves in a caterpillar manner by the rotation of a drive pulley. A belt of the first transporting conveyor 110 may be made of a material having a lower reflectivity than the first electrode sheet 11. However, the first transporting conveyor 110 may be changed in design to any type of transporting unit capable of transporting the first electrode sheet 11 in the first direction, such as a roller conveyor and a chain conveyor.

A longitudinal direction of the first transporting conveyor 110 may be disposed in the first direction. A plurality of first electrode sheets 11 may be arranged on the first transporting conveyor 110 at set intervals in the first direction. The first transporting conveyor 110 may continuously transport the plurality of first electrode sheets 11 in the first direction by the movement of the belt.

The first transporting conveyor 110 may include a first supply area 111 that receives the first electrode sheet 11 from the supply member 200.

The first supply area 111 according to the present embodiment may be an area of one end portion of the first transporting conveyor 110 at which the transport of the first electrode sheet 11 starts among the entire area of the first transporting conveyor 110. The first electrode sheet 11 supplied from the supply member 200 may be seated on the first supply area 111. The electrode sheet 10 seated on the first supply area 111 may be transported in the first direction by the operation of the first transporting conveyor 110.

The second transporting conveyor 120 may transport the second electrode sheet 12 in the direction opposite to the first direction.

The second transporting conveyor 120 according to the present embodiment may be a typical belt conveyor type in which a belt moves in a caterpillar manner by the rotation of a drive pulley. A belt of the second transporting conveyor 120 may be made of a material having a lower reflectivity than the second electrode sheet 12. However, the second transporting conveyor 120 may be changed in design to any type of transporting unit capable of transporting the second electrode sheet 12 in the direction opposite to the first direction, such as a roller conveyor and a chain conveyor.

A longitudinal direction of the second transporting conveyor 120 may be disposed in the first direction. A plurality of second electrode sheets 12 may be arranged on the second transporting conveyor 120 at set intervals in the direction opposite to the first direction. The second transporting conveyor 120 may continuously transport the plurality of second electrode sheets 12 in the direction opposite to the first direction by the movement of the belt.

The second transporting conveyor 120 may be disposed to face the first transporting conveyor 110 in the second direction. For example, the second transporting conveyor 120 may be disposed at a position spaced a predetermined distance from the first transporting conveyor 110 in the direction opposite to the second direction.

The second transporting conveyor 120 may include a second supply area 121 that receives the second electrode sheet 12 from the supply member 200.

The second supply area 121 according to the present embodiment may be an area of one end portion of the second transporting conveyor 120 at which the transport of the second electrode sheet 12 starts among the entire area of the second transporting conveyor 120. The second electrode sheet 12 supplied from the supply member 200 may be seated on the second supply area 121. The electrode sheet 10 seated on the second supply area 121 may be transported in the direction opposite to the first direction (+Y-axis direction) by the operation of the second transporting conveyor 120.

The first supply area 111 and the second supply area 121 may be arranged in the second direction. For example, the second supply area 121 may be disposed at a position spaced a predetermined distance from the first supply area 111 in the direction opposite to the second direction.

The supply member 200 may supply the first electrode sheet 11 to the first supply area 111 of the first transporting conveyor 110 and supply the second electrode sheet 12 to the second supply area 121 of the second transporting conveyor 120.

The supply member 200 according to the present embodiment may include a supply conveyor 210 and a conveying unit 220.

The supply conveyor 210 may transport the first electrode sheet 11 and the second electrode sheet 12 in the second direction.

The supply conveyor 210 according to the present embodiment may be a typical belt conveyor type in which a belt moves in a caterpillar manner by the rotation of a drive pulley.

The supply conveyor 210 may be disposed to intersect the first transporting conveyor 110 and the second transporting conveyor 120. A longitudinal direction of the supply conveyor 210 may be disposed in the second direction. A plurality of first electrode sheets 11 and a plurality of second electrode sheets 12 may be arranged alternately on the supply conveyor 210 in the second direction. The supply conveyor 210 may continuously transport the plurality of first electrode sheets 11 and the plurality of second electrode sheets 12 in the second direction by the movement of the belt.

An end portion of the supply conveyor 210 may be disposed to face the second supply area 121 of the second transporting conveyor 120 in the second direction. Therefore, the end portion of the supply conveyor 210, the second supply area 121, and the first supply area 111 may be sequentially arranged in the second direction.

The conveying unit 220 may convey the first electrode sheet 11 and the second electrode sheet 12 transported by the supply conveyor 210 to the first supply area 111 and the second supply area 121, respectively.

The conveying unit 220 according to the present embodiment may reciprocate between the supply conveyor 210 and the first transporting conveyor 110. For example, the conveying unit 220 may repeatedly perform an operation of moving from the supply conveyor 210 onto the first transporting conveyor 110 and the second transporting conveyor 120 in the second direction and then moving toward the supply conveyor 210 on the first transporting conveyor 110 and the second transporting conveyor 120 in the direction opposite to the second direction (+X-axis direction).

The conveying unit 220 may move in the third direction and in the direction opposite to the third direction on the supply conveyor 210 and pick up the first electrode sheet 11 and the second electrode sheet 12. For example, the conveying unit 220 may include an adsorber for adsorbing the electrode sheet 11 and the electrode sheet 12 by a vacuum pressure or a gripper for gripping the electrode sheet 11 by a gripping operation.

The conveying unit 220 may move in the third direction toward the electrode sheet 11 (and electrode sheet 12) on the supply conveyor 210 and have both sides each coming into contact with one of the first electrode sheet 11 and the second electrode sheet 12. The first electrode sheet 11 and the second electrode sheet 12 may be fixed to the conveying unit 220 by an adsorbing or gripping method. Then, the conveying unit 220 may move in the direction opposite to the third direction from the supply conveyor 210 and move toward the first transporting conveyor 110 and the second transporting conveyor 120 in the second direction.

The conveying unit 220 may move from the supply conveyor 210 in the second direction and then move in the third direction and in the direction opposite to the third direction on the transporting conveyor 100 to seat the first electrode sheet 11 and the second electrode sheet 12 on the first supply area 111 and the second supply area 121, respectively.

For example, the conveying unit 220 may move in the third direction in a state in which one side that fixes the first electrode sheet 11 is disposed to face the first supply area 111 and the other side that fixes the second electrode sheet 12 is disposed to face the second supply area 121. Then, the conveying unit 220 may seat the first electrode sheet 11 and the second electrode sheet 12 on the first supply area 111 and the second supply area 121, respectively, by the method of releasing the adsorption of the first electrode sheet 11 and the second electrode sheet 12 by the adsorber or releasing the grip of the first electrode sheet 11 and the second electrode sheet 12 by the gripper. Then, the conveying unit 220 may move in the direction opposite to the third direction and move in the direction opposite to the second direction toward the supply conveyor 210.

The lighting member 300 may radiate light to the first supply area 111 and the second supply area 121.

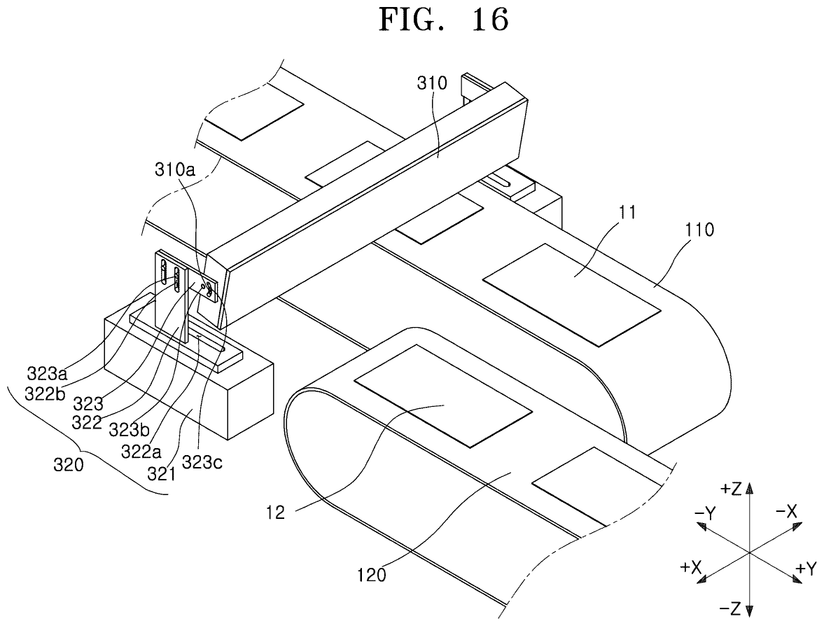

FIG. 16 is a schematic perspective view showing a configuration of a lighting member according to the second embodiment of the present disclosure.

Referring to FIGS. 14 to 16, the lighting member 300 according to the present embodiment may include the light source 310 and the lighting bracket 320.

The light source 310 may be spaced apart from the first transporting conveyor 110 and the second transporting conveyor 120 and may radiate light toward the first supply area 111 and the second supply area 121.

The light source 310 according to the present embodiment may be disposed above the first transporting conveyor 110. The light source 310 may be disposed at a position spaced a predetermined distance from the first supply area 111 and the second supply area 121 in the first direction.

The light source 310 may include a case having a substantially rectangular box shape and any type of light-emitting device, such as a light emitting diode (LED), a fluorescent lamp, an incandescent lamp, a halogen lamp, or a laser, disposed inside the case. Light generated from the light-emitting device may be radiated to the first supply area 111 and the second supply area 121 through one surface of the light source 310 disposed to face the first supply area 111 and the second supply area 121.

The width of the light source 310 in the second direction may be greater than the sum of the width of the first transporting conveyor 110 in the second direction and the width of the second transporting conveyor 120 in the second direction. Therefore, the light source 310 may radiate light over the overall width of the first supply area 111 and the second supply area 121.

The lighting bracket 320 may support the light source 310.

The lighting bracket 320 according to the present embodiment may include the first lighting bracket 321, the second lighting bracket 322, and the third lighting bracket 323.

The first lighting bracket 321 may form the exterior of one side of the lighting bracket 320 and support the second lighting bracket 322.

A pair of first lighting brackets 321 according to the present embodiment may be provided. The pair of first lighting brackets 321 may be disposed to face each other in the second direction. A space between the pair of first lighting brackets 321 may be greater than the width of the light source 310 in the second direction. The first lighting bracket 321 may be fixed to frames of the first transporting conveyor 110 and the second transporting conveyor 120 or otherwise may be fixed on the ground.

The second lighting bracket 322 and the third lighting bracket 323 may be formed in the same manner as the second lighting bracket 322 and the third lighting bracket 323 described with reference to FIGS. 1 to 13.

The sensing member 400 may be disposed to face the lighting member 300. The sensing member 400 may detect the presence or absence of the first electrode sheet 11 and the second electrode sheet 12 on the first supply area 111 and the second supply area 121, respectively, based on the light radiated from the lighting member 300. The sensing member 400 may detect the light reflected from the first electrode sheet 11 positioned on the first supply area 111 and the second electrode sheet 12 positioned on the second supply area 121.

The sensing member 400 according to the present embodiment may include the camera 410 and the camera bracket 420.

The camera 410 may acquire optical images of the first supply area 111 and the second supply area 121.

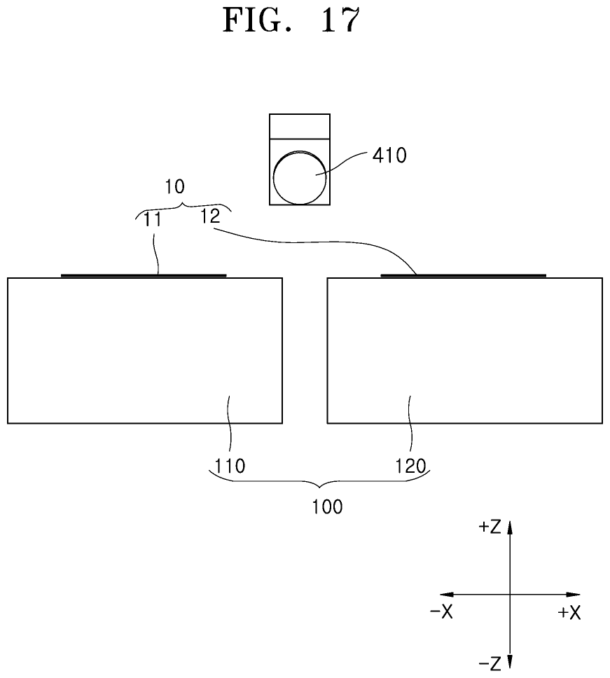

FIG. 17 is a schematic view showing a configuration of a camera according to the second embodiment of the present disclosure.

Referring to FIGS. 14 to 17, the camera 410 according to the present embodiment may be exemplified as any type of optical device capable of detecting the light reflected from the first electrode sheet 11 positioned on the first supply area 111 and the second electrode sheet 12 positioned on the second supply area 121, such as a mono camera, a color camera, or a vision sensor.

The camera 410 may be disposed between the first transporting conveyor 110 and the second transporting conveyor 120. Therefore, the camera may uniformly detect the light reflected from the first electrode sheet 11 and the second electrode sheet 12 positioned on the first supply area 111 and the second supply area 121, respectively.

The camera 410 may be disposed to face the lighting member 300, more specifically, the light source 310 in the first direction. The camera 410 may be disposed to face the light source 310 in the first direction with the first supply area 111 and the second supply area 121 interposed therebetween. The camera 410 may be disposed at a position spaced a predetermined distance from the lighting member 300 in the direction opposite to the first direction.

The camera bracket 420 may support the camera 410.

The camera bracket 420 according to the present embodiment may be formed in the same manner as the camera bracket 420 described with reference to FIGS. 1 to 13.

The control member 500 may control the overall operation of the first transporting conveyor 110, the second transporting conveyor 120, the supply member 200, the lighting member 300, and the sensing member 400.

The control member 500 may control the supply operation of the supply member 200 based on information detected from the sensing member 400. More specifically, the control member 500 may determine the presence or absence of the first electrode sheet 11 on the first supply area 111 and the presence or absence of the second electrode sheet 12 on the first supply area 111 and the second supply area 121, respectively, based on the information detected from the sensing member 400. When the control member 500 determines that the first electrode sheet 11 and the second electrode sheet 12 are not present on both the first supply area 111 and the second supply area 121, the control member 500 may operate the supply member 200. When the control member 500 determines that the first electrode sheet 11 and the second electrode sheet 12 are present on at least one of the first supply area 111 and the second supply area 121, the control member 500 may stop the operation of the supply member 200. Therefore, the control member 500 can prevent two or more electrode sheets 10 from overlapping at the same position on the first transporting conveyor 110 and the second transporting conveyor 120.

In addition, the control member 500 may control the operation of a drive pulley of the first transporting conveyor 110 to adjust a transporting speed of the first electrode sheet 11, a transporting direction of the first electrode sheet 11, whether the first electrode sheet 11 is transported, and the like.

In addition, the control member 500 may control the operation of a drive pulley of the second transporting conveyor 120 to adjust a transporting speed of the second electrode sheet 12, a transporting direction of the second electrode sheet 12, whether the second electrode sheet 12 is transported, and the like.

In addition, the control member 500 may control the operations of the actuators of the lighting member 300 and the sensing member 400 to adjust the positions, angles, and the like of the light source 310 and the camera 410.

Hereinafter, the operation of the electrode sheet transporting apparatus according to the second embodiment of the present disclosure will be described.

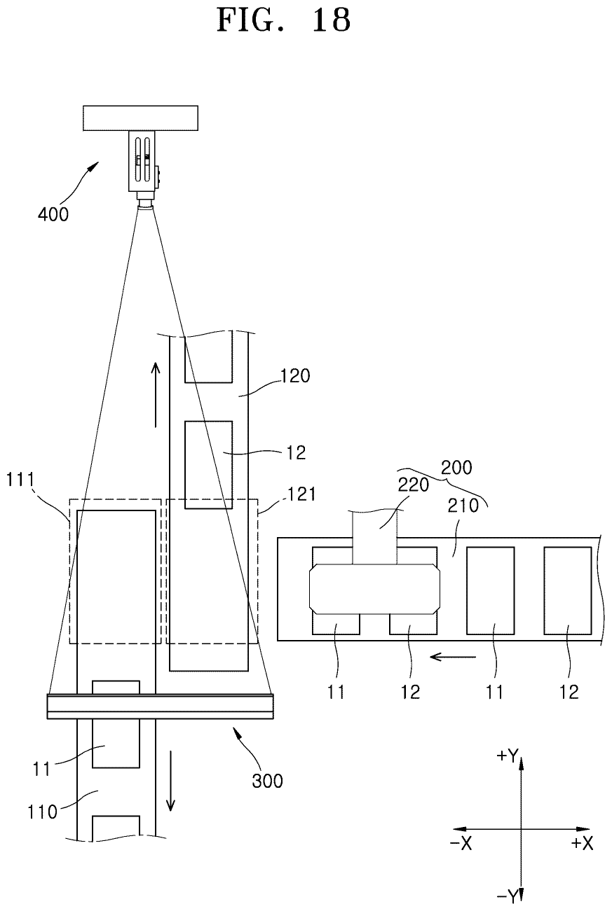

FIGS. 18 to 21 are schematic views showing an operation process of the electrode sheet transporting apparatus according to the second embodiment of the present disclosure.

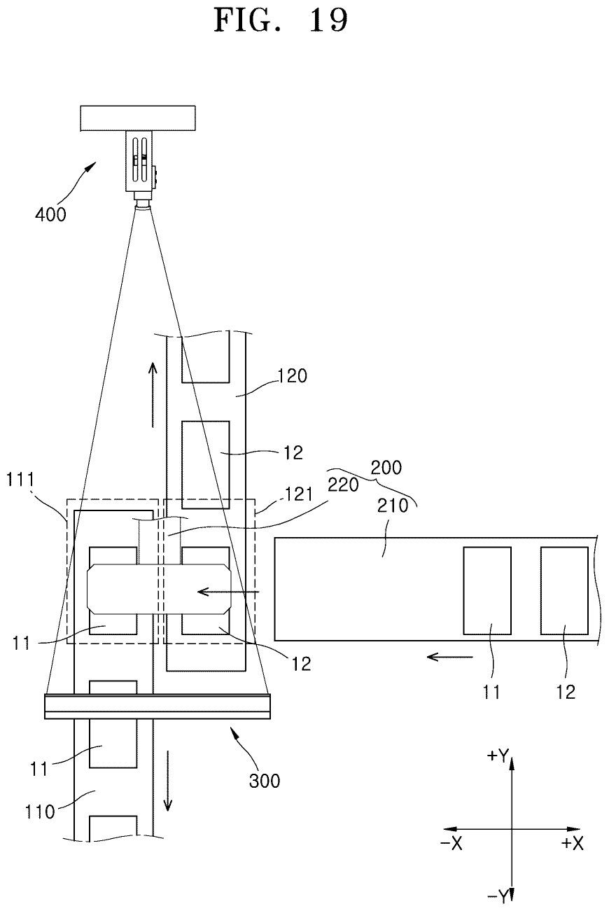

Referring to FIGS. 18 and 19, when the first transporting conveyor 110 operates, the first electrode sheet 11 positioned on the first supply area 111 moves from the first supply area 111 in the first direction, and the first electrode sheet 11 is not present on the first supply area 111.

When the second transporting conveyor 120 operates, the second electrode sheet 12 positioned on the second supply area 121 moves from the second supply area 121 in the direction opposite to the first direction, and the second electrode sheet 12 is not present on the second supply area 121.

When both the first electrode sheet 11 and the second electrode sheet 12 are not present on the first supply area 111 and the second supply area 121, the light radiated from the light source 310 to the first supply area 111 and the second supply area 121 is not reflected from the first supply area 111 and the second supply area 121 or is reflected with the same reflectivity over the entire area of the first supply area 111 and the second supply area 121.

Therefore, light is not incident on the camera 410, or light with the same brightness is incident on the entire area of the first supply area 111 and the second supply area 121, and the control member 500 determines that the electrode sheet 10 is not present on the first supply area 111 and the second supply area 121.

Then, the control member 500 operates the supply member 200 so that the first electrode sheet 11 and the second electrode sheet 12 are supplied to the first supply area 111 and the second supply area 121.

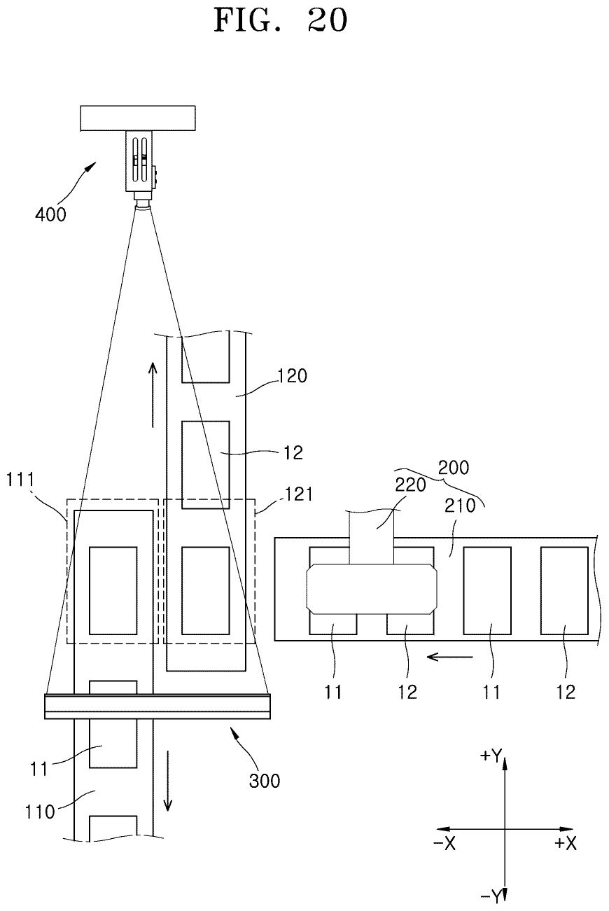

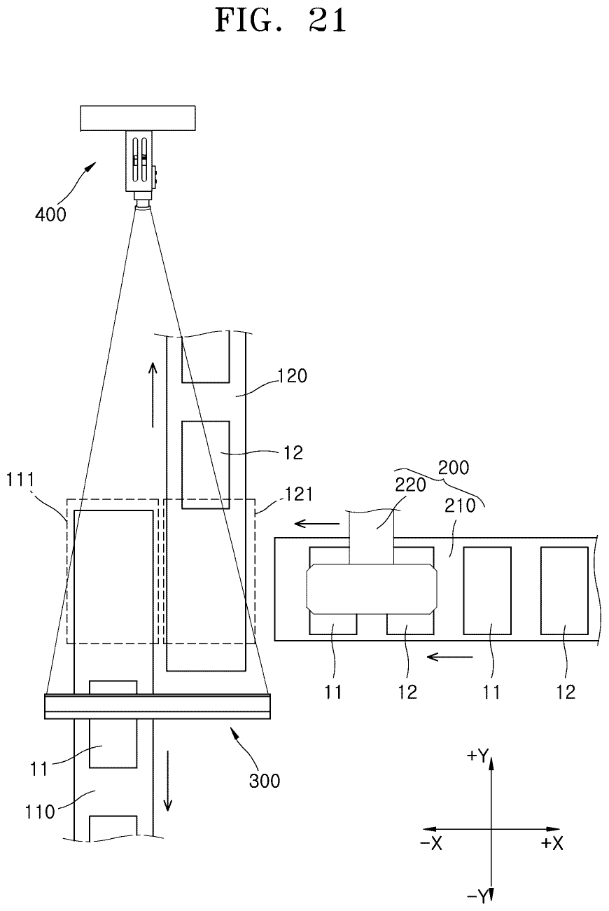

Referring to FIGS. 20 and 21, when an operation error occurs in the first transporting conveyor 110, the first electrode sheet 11 positioned on the first supply area 111 does not move in the first direction, and the first electrode sheet 11 is present on the first supply area 111.

Since the first electrode sheet 11 is made of a material having a higher reflectivity than the belt of the first transporting conveyor 110, light of different brightness is incident on the camera 410 in the area in which the first electrode sheet 11 is positioned and in the area in which the first electrode sheet 11 is not positioned on the first supply area 111, and the control member 500 may determine that the first electrode sheet 11 is present on the first supply area 111.

When an operation error occurs in the second transporting conveyor 120, the second electrode sheet 12 positioned on the second supply area 121 does not move in the direction opposite to the first direction, and the second electrode sheet 12 is present on the second supply area 121.

Since the second electrode sheet 12 is made of a material having a higher reflectivity than the belt of the second transporting conveyor 120, light of different brightness is incident on the camera 410 in the area in which the second electrode sheet 12 is positioned and in the area in which the second electrode sheet 12 is not positioned on the second supply area 121, and the control member 500 may determine that the second electrode sheet 12 is present on the second supply area 121.

When the control member 500 determines that the first electrode sheet 11 and the second electrode sheet 12 are present on at least one of the first supply area 111 and the second supply area 121, the control member 500 stops the operation of the supply member 200 so that the first electrode sheet 11 and the second electrode sheet 12 are not supplied to the first supply area 111 and the second supply area 121.

Hereinafter, an operation of an electrode sheet transporting apparatus according to a third embodiment of the present disclosure will be described.

The electrode sheet transporting apparatus according to the present (third) embodiment may be formed to differ only in the detailed configuration of the lighting member 300 from the electrode sheet transporting apparatus according to the second embodiment of the present disclosure.

Therefore, in describing the electrode sheet transporting apparatus according to the present embodiment, only the detailed configuration of the lighting member 300 that differs from the electrode sheet transporting apparatus according to the second embodiment of the present disclosure will be described.

The description of the electrode sheet transporting apparatus according to the second embodiment of the present disclosure may be applied to the remaining configuration of the electrode sheet transporting apparatus according to the present embodiment.

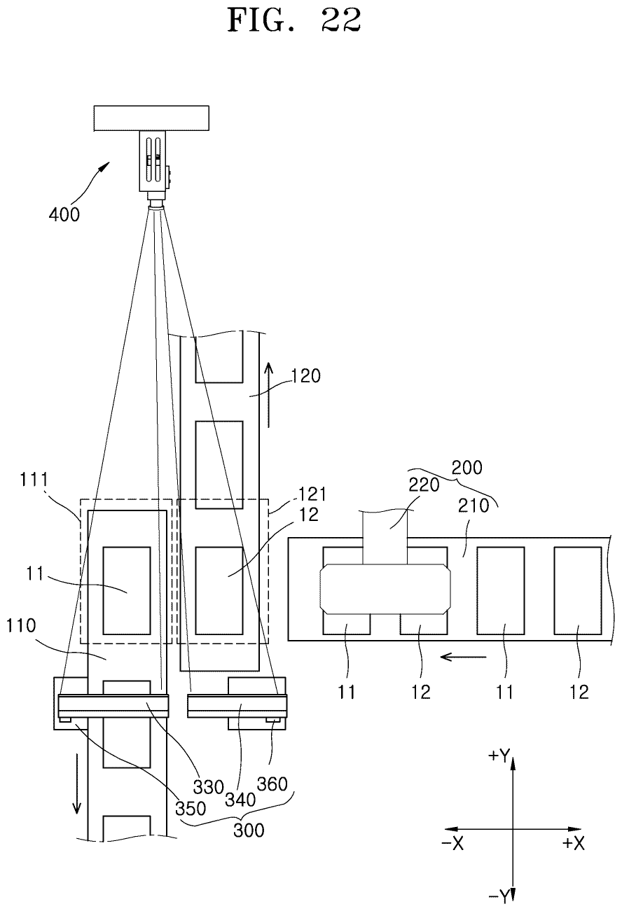

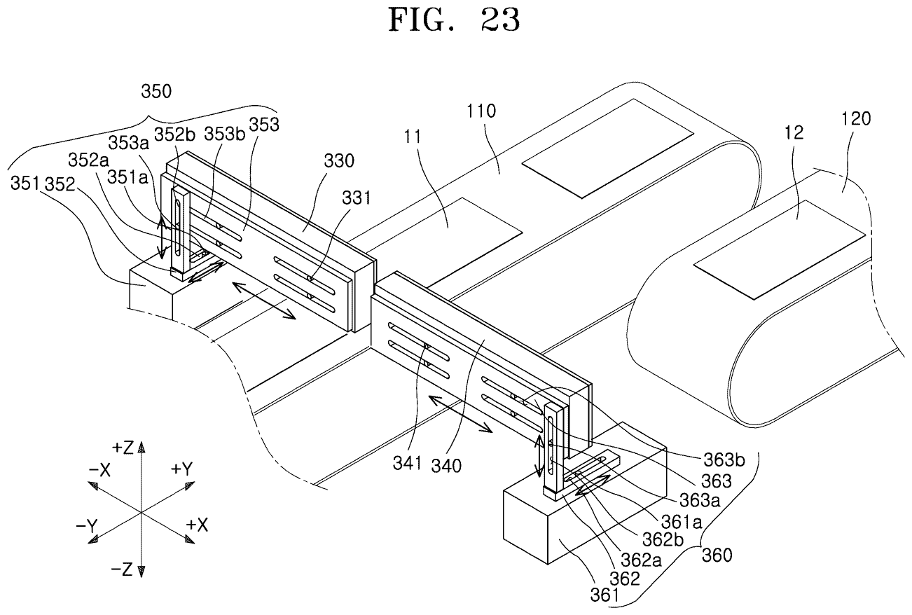

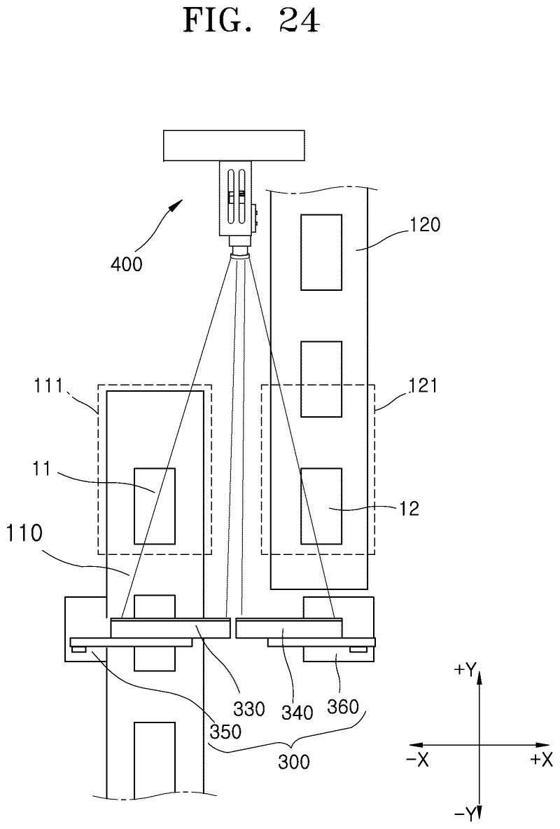

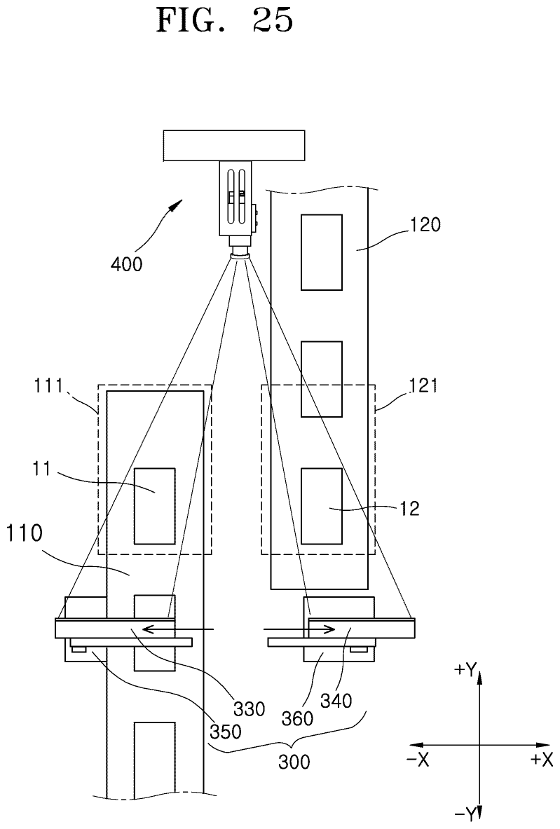

FIG. 22 is a schematic view showing a configuration of an electrode sheet transporting apparatus according to a third embodiment of the present disclosure, FIG. 23 is a schematic perspective view showing a configuration of a lighting member according to the third embodiment of the present disclosure, and FIGS. 24 and 25 are schematic views showing an operation process of the lighting member according to the third embodiment of the present disclosure.

Referring to FIGS. 21 to 24, the lighting member 300 according to the present embodiment may include a first light source 330, a second light source 340, a first support bracket 350, and a second support bracket 360. Therefore, the lighting member 300 according to the present embodiment may independently adjust the brightness, position, and the like of light radiated to the first supply area 111 and the second supply area 121.

The first light source 330 may radiate light to the first supply area 111.

The first light source 330 according to the present embodiment may be disposed above the first transporting conveyor 110. The first light source 330 may be disposed to face the first transporting conveyor 110 in the third direction and may not be disposed to face the first transporting conveyor 110 in the third direction. The first light source 330 may be disposed at a position spaced a predetermined distance from the first supply area 111 in the first direction.

The first light source 330 may include a case having a substantially rectangular box shape and any type of light-emitting device, such as a light emitting diode (LED), a fluorescent lamp, an incandescent lamp, a halogen lamp, or a laser, disposed inside the case. Light generated from the light-emitting device may be radiated to the first supply area 111 through one surface of the first light source 330 disposed to face the first supply area 111.

A width of the first light source 330 in the second direction may be greater than a width of the first transporting conveyor 110 in the second direction. Therefore, the first light source 330 may radiate light over the overall width of the first supply area 111.

The second light source 340 may radiate light to the second supply area 121.

The second light source 340 according to the present embodiment may be disposed above the second transporting conveyor 120. The second light source 340 may not be disposed to face the second transporting conveyor 120 in the third direction and may be disposed to face the second transporting conveyor 120 in the third direction. The second light source 340 may be disposed at a position spaced a predetermined distance from the second supply area 121 in the first direction.

The second light source 340 may include a case having a substantially rectangular box shape and any type of light-emitting device, such as a light emitting diode (LED), a fluorescent lamp, an incandescent lamp, a halogen lamp, or a laser, disposed inside the case. Light generated from the light-emitting device may be radiated to the second supply area 121 through one surface of the second light source 340 disposed to face the second supply area 121.

A width of the second light source 340 in the second direction may be greater than a width of the second transporting conveyor 120 in the second direction. Therefore, the second light source 340 may radiate light over the overall width of the second supply area 121.

The first light source 330 and the second light source 340 may be disposed to face each other in the second direction. The second light source 340 may be disposed at a position spaced a predetermined distance from the first light source 330 in the direction opposite to the second direction.

The first support bracket 350 may support the first light source 330.

The first support bracket 350 according to the present embodiment may include a first bracket body 351, a first connection bracket 352, and a first extension bracket 353.

The first bracket body 351 may form the exterior of one side of the first support bracket 350 and support the first connection bracket 352.

The first bracket body 351 according to the present embodiment may be disposed to face the first transporting conveyor 110 in the second direction. The first bracket body 351 may be disposed at a position spaced a predetermined distance from the first transporting conveyor 110 in the second direction. The first bracket body 351 may be fixed to a frame of the first transporting conveyor 110 or otherwise may be fixed on the ground. The shape of the first bracket body 351 shown in FIGS. 22 and 23 may be changed in design in various ways within the technical spirit of the shape capable of supporting the first connection bracket 352.

The first connection bracket 352 may be connected to the first bracket body 351 to support the first extension bracket 353.

The first connection bracket 352 according to the present embodiment may have a shape in which a lower side is seated on the first bracket body 351 and an upper side extends upward from the first bracket body 351, that is, in the direction opposite to the third direction. A height of an upper end portion of the first connection bracket 352 may be greater than a height of the first electrode sheet 11 seated on the first transporting conveyor 110. Therefore, the first connection bracket 352 can prevent interference between the first light source 330 and the first electrode sheet 11.

The first connection bracket 352 may be connected to the first bracket body 351 to be movable in the first direction and in the direction opposite to the first direction. Therefore, the first connection bracket 352 may adjust a space between the first light source 330 and the sensing member 400.

For example, the lighting member 300 may further include a first horizontal rail 352a passing through the first connection bracket 352. The first horizontal rail 352a according to the present embodiment may pass through a lower portion of the first connection bracket 352 seated on the first bracket body 351 in the third direction. A longitudinal direction of the first horizontal rail 352a may extend in the first direction.

The lighting member 300 may further include a first vertical pin 351a protruding from the first bracket body 351 and inserted into the first horizontal rail 352a. The first vertical pin 351a according to the present embodiment may have a rod shape that extends from an upper surface of the first bracket body 351 on which the first connection bracket 352 is seated in the direction opposite to the third direction.

The first connection bracket 352 may slide in the first direction or in the direction opposite to the first direction by an external force applied from the outside in a state in which the first vertical pin 351a is inserted into the first horizontal rail 352a.

However, the connection relationship between the first bracket body 351 and the first connection bracket 352 may be changed in design in various ways within the range of a structure in which the first connection bracket 352 may move relatively with respect to the first bracket body 351 in the first direction.

The first extension bracket 353 may extend from the first connection bracket 352 to support the first light source 330.

The first extension bracket 353 according to the present embodiment may have a plate shape that extends from the upper end portion of the first connection bracket 352 in the direction opposite to the second direction. A rear surface of the first extension bracket 353 may be disposed to face the upper end portion of the first connection bracket 352 in the first direction. A front surface of the first extension bracket 353 may be disposed to face a rear surface of the first light source 330 in the first direction.

The first extension bracket 353 may be connected to the first connection bracket 352 to be movable in the third direction or in the direction opposite to the third direction. Therefore, the first extension bracket 353 may adjust a height of the first light source 330 in response to a difference in height between the conveying unit 220 and the first supply area 111 when the first electrode sheet 11 is supplied.

For example, the lighting member 300 may further include a first vertical rail 352b passing through the first connection bracket 352. The first vertical rail 352b according to the present embodiment may pass through the upper end portion of the first connection bracket 352 facing the rear surface of the first extension bracket 353 in the first direction. A longitudinal direction of the first vertical rail 352b may extend in the third direction.

The lighting member 300 may further include a first horizontal pin 353a protruding from the first extension bracket 353 and inserted into the first vertical rail 352b. The first horizontal pin 353a according to the present embodiment may have a rod shape that extends from one end portion of the first extension bracket 353 facing the first connection bracket 352 in the direction parallel to the first direction.

The first extension bracket 353 may slide in the third direction or in the direction opposite to the third direction by an external force applied from the outside in a state in which the first horizontal pin 353a is inserted into the first vertical rail 352b.

The first light source 330 may be connected to the first extension bracket 353 to be movable in the second direction or in the direction opposite to the second direction. Therefore, the lighting member 300 according to the present embodiment may adjust an incident angle of light incident on the camera 410 according to the size of the first electrode sheet 11 seated on the first supply area 111 or the like.

For example, the lighting member 300 may further include a first guide rail 353b passing through the first extension bracket 353. The first guide rail 353b according to the present embodiment may pass through the front and rear surfaces of the first extension bracket 353 in the first direction. A longitudinal direction of the first guide rail 353b may extend in the second direction.

The lighting member 300 may further include a first guide pin 331 protruding from the first light source 330 and inserted into the first guide rail 353b. The first guide pin 331 according to the present embodiment may have a rod shape that extends from the rear surface of the first light source 330 facing the first extension bracket 353 in the first direction.

The first light source 330 may slide in the second direction or in the direction opposite to the second direction by an external force applied from the outside in a state in which the first guide pin 331 is inserted into the first guide rail 353b.

The second support bracket 360 may support the second light source 340.

The second support bracket 360 according to the present embodiment may include a second bracket body 361, a second connection bracket 362, and a second extension bracket 363.

The second bracket body 361 may form the exterior of one side of the second support bracket 360 and support the second connection bracket 362.

The second bracket body 361 according to the present embodiment may be disposed to face the first bracket body 351 in the second direction. The second bracket body 361 may be disposed at a position spaced a predetermined distance from the first bracket body 351 in the direction opposite to the second direction. A space between the first bracket body 351 and the second bracket body 361 may be greater than a space between the outer surfaces of the first transporting conveyor 110 and the second transporting conveyor 120. The second bracket body 361 may be fixed to the frame of the first transporting conveyor 110 or the second transporting conveyor 120 or otherwise may be fixed on the ground (e.g., the floor). The shape of the second bracket body 361 shown in FIGS. 22 and 23 may be changed in design in various ways within the technical spirit of the shape capable of supporting the second connection bracket 362.

The second connection bracket 362 may be connected to the second bracket body 361 to support the second extension bracket 363.

The second connection bracket 362 according to the present embodiment may have a shape in which a lower side is seated on the second bracket body 361 and an upper side extends upward from the second bracket body 361, that is, in the direction opposite to the third direction (the −Z-axis direction). A height of an upper end portion of the second connection bracket 362 may be greater than a height of the second electrode sheet 12 seated on the second transporting conveyor 120. Therefore, the second connection bracket 362 can prevent interference between the second light source 340 and the second electrode sheet 12.

The second connection bracket 362 may be connected to the second bracket body 361 to be movable in the first direction and in the direction opposite to the first direction. Therefore, the second connection bracket 362 may adjust a space between the second light source 340 and the sensing member 400.

For example, the lighting member 300 may further include a second horizontal rail 362a passing through the second connection bracket 362. The second horizontal rail 362a according to the present embodiment may pass through a lower portion of the second connection bracket 362 seated on the second bracket body 361 in the third direction. A longitudinal direction of the second horizontal rail 362a may extend in the first direction.

The lighting member 300 may further include a second guide rail 361a protruding from the second bracket body 361 and inserted into the second horizontal rail 362a. The second guide rail 361a according to the present embodiment may have a rod shape that extends from an upper surface of the second bracket body 361 on which the second connection bracket 362 is seated in the direction opposite to the third direction.

The second connection bracket 362 may slide in the first direction or in the direction opposite to the first direction by an external force applied from the outside in a state in which the second guide rail 361a is inserted into the second horizontal rail 362a.

However, the connection relationship between the second bracket body 361 and the second connection bracket 362 may be changed in design in various ways within the range of a structure in which the second connection bracket 362 may move relatively with respect to the second bracket body 361 in the first direction.

The second extension bracket 363 may extend from the second connection bracket 362 to support the second light source 340.

The second extension bracket 363 according to the present embodiment may have a plate shape that extends from the upper end portion of the second connection bracket 362 in the second direction. A rear surface of the second extension bracket 363 may be disposed to face the upper end portion of the second connection bracket 362 in the first direction. A front surface of the second extension bracket 363 may be disposed to face a rear surface of the second light source 340 in the first direction.

The second extension bracket 363 may be connected to the second connection bracket 362 to be movable in the third direction or in the direction opposite to the third direction. Therefore, the second extension bracket 363 may adjust a height of the second light source 340 in response to a difference in height between the conveying unit 220 and the second supply area 121 when the second electrode sheet 12 is supplied.

For example, the lighting member 300 may further include a second vertical rail 362b passing through the second connection bracket 362. The second vertical rail 362b according to the present embodiment may pass through the upper end portion of the second connection bracket 362 facing the rear surface of the second extension bracket 363 in the first direction. A longitudinal direction of the second vertical rail 362b may extend in the third direction.

The lighting member 300 may further include a second horizontal pin 363a protruding from the second extension bracket 363 and inserted into the second vertical rail 362b. The second horizontal pin 363a according to the present embodiment may have a rod shape that extends from one end portion of the second extension bracket 363 facing the second connection bracket 362 in the direction parallel to the first direction.

The second extension bracket 363 may slide in the third direction or in the direction opposite to the third direction by an external force applied from the outside in a state in which the second horizontal pin 363a is inserted into the second vertical rail 362b.

The second light source 340 may be connected to the second extension bracket 363 to be movable in the third direction or in the direction opposite to the third direction. Therefore, the lighting member 300 according to the present embodiment may adjust an incident angle of light incident on the camera 410 according to the size of the second electrode sheet 12 seated on the second supply area 121 or the like.

For example, the lighting member 300 may further include a second guide rail 361a passing through the second extension bracket 363. The second guide rail 361a according to the present embodiment may pass through the front and rear surfaces of the second extension bracket 363 in the first direction. A longitudinal direction of the second guide rail 361a may extend in the second direction.

The lighting member 300 may further include a first guide pin 341 protruding from the back of the second light source 340 and inserted into the second guide rail 361a. The first guide pin 341 according to the present embodiment may have a rod shape that extends from the rear surface of the second light source 340 facing the second extension bracket 363 in the first direction.

The second light source 340 may slide in the second direction or in the direction opposite to the second direction by an external force applied from the outside in a state in which the first guide pin 341 is inserted into the second guide rail 361a.

The lighting member 300 according to the present embodiment may further include an actuator such as a motor and a power transmission unit such as a reducer to move or rotate the first light source 330, the second light source 340, the first support bracket 350, and the second support bracket 360 by their own driving force.

Hereinafter, an electrode sheet transporting apparatus according to a fourth embodiment of the present disclosure will be described.

The electrode sheet transporting apparatus according to the present embodiment may be formed to differ only in the detailed configuration of the lighting member 300 from the electrode sheet transporting apparatus according to the third embodiment of the present disclosure.

Therefore, in describing the electrode sheet transporting apparatus according to the present embodiment, only the detailed configuration of the lighting member 300 that differs from the electrode sheet transporting apparatus according to the third embodiment of the present disclosure will be described.

The description of the electrode sheet transporting apparatus according to the second embodiment of the present disclosure may be applied to the remaining configuration of the electrode sheet transporting apparatus according to the present embodiment.

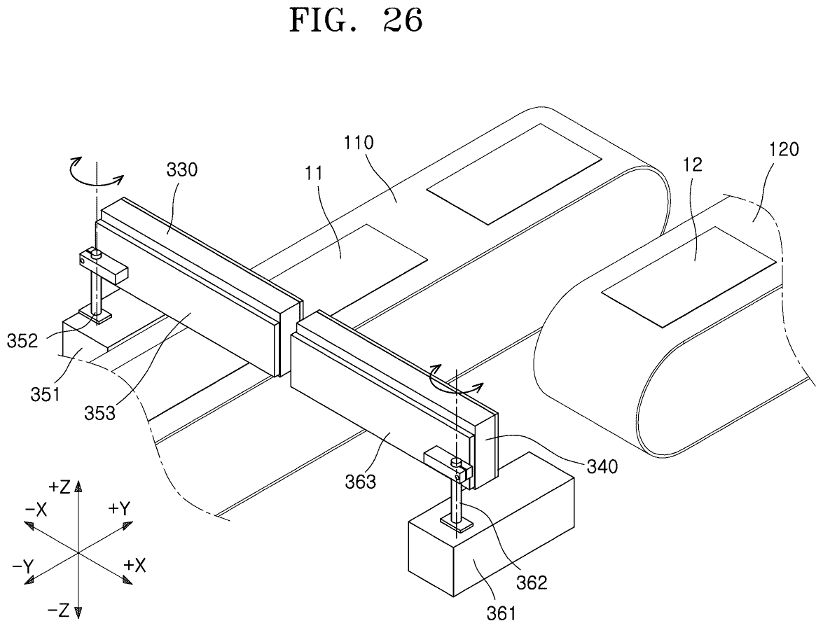

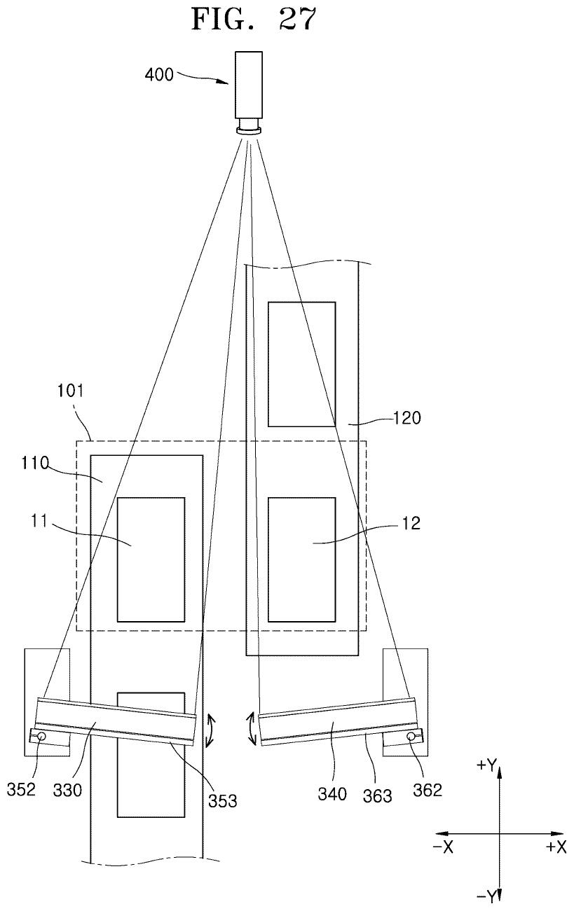

FIG. 26 is a schematic perspective view showing a configuration of a lighting member according to a fourth embodiment of the present disclosure, and FIG. 27 is a schematic plan view showing an operation of the lighting member according to the fourth embodiment of the present disclosure.

Referring to FIGS. 26 and 27, the first extension bracket 353 according to the present embodiment may be rotatably connected to the first connection bracket 352 clockwise or counterclockwise with respect to the third direction (e.g., in an X-Y plane).

For example, the first connection bracket 352 may have a cylindrical shape that extends from the first bracket body 351 in the direction opposite to the third direction. The upper end portion of the first connection bracket 352 may be inserted into the first extension bracket 353 to rotatably support the first extension bracket 353. The first extension bracket 353 may be rotated about a central axis of the first connection bracket 352 clockwise or counterclockwise by an external force applied from the outside.

The second extension bracket 363 according to the present embodiment may be rotatably connected to the second connection bracket 362 clockwise or counterclockwise with respect to the third direction (e.g., in an X-Y plane).

For example, the second connection bracket 362 may have a cylindrical shape that extends from the second bracket body 361 in the direction opposite to the third direction. The upper end portion of the second connection bracket 362 may be inserted into the second extension bracket 363 to rotatably support the second extension bracket 363. The second extension bracket 363 may be rotated about a central axis of the second connection bracket 362 clockwise or counterclockwise by an external force applied from the outside.

In the case of the conventional stack manufacturing apparatus, a situation, in which a plurality of electrode sheets overlap on a conveyor due to errors in electronic systems or the like, occurred. When a stack process is performed in such a state, there is a problem that the electrode sheet is damaged or damage to an adjacent device occurs.

The present disclosure is directed to providing an electrode sheet transporting apparatus capable of preventing a plurality of electrode sheets from overlapping on a conveyor.

According to the present disclosure, by detecting the presence or absence of an electrode sheet at a supply position on a transporting conveyor in real time, it is possible to prevent damage to a device and degradation in the quality of products due to the overlapping of a plurality of electrode sheets.

According to the present disclosure, it is possible to prevent a lighting member and a sensing member from interfering with a supply member in a stack device having a narrow space.

However, the effects obtainable through the present disclosure are not limited to the above effects, and other technical effects that are not mentioned will be clearly understood by those skilled in the art from the following description of the present disclosure.

While the present disclosure has been described with reference to embodiments shown in the drawings, these embodiments are merely illustrative and it should be understood that various modifications and equivalent other embodiments can be derived by those skilled in the art on the basis of the embodiments.

Therefore, the technical scope of the present disclosure should be defined by the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An electrode sheet transporting apparatus, comprising:
a first transporting conveyor having a supply area receiving an electrode sheet, the first transporting conveyor being configured to transport the electrode sheet in a first direction;
a supply member configured to supply the electrode sheet to the supply area;
a lighting member configured to radiate light to the supply area; and
a sensing member facing the lighting member, the sensing member being configured to detect light reflected from the electrode sheet on the supply area.

2. The electrode sheet transporting apparatus as claimed in claim 1, wherein the supply member comprises:
a supply conveyor transporting the electrode sheet in a second direction intersecting the first direction; and
a conveying unit configured to convey the electrode sheet transported by the supply conveyor to the supply area.

3. The electrode sheet transporting apparatus as claimed in claim 2, wherein:
the supply conveyor and the supply area face each other in the second direction, and
the conveying unit is further configured to reciprocate in the second direction.

4. The electrode sheet transporting apparatus as claimed in claim 3, wherein the conveying unit is configured to pass through a space between the lighting member and the sensing member.

5. The electrode sheet transporting apparatus as claimed in claim 1, wherein the lighting member comprises:
a light source; and
a lighting bracket supporting the light source.

6. The electrode sheet transporting apparatus as claimed in claim 5, wherein the lighting bracket comprises:
a first lighting bracket;
a second lighting bracket connected to the first lighting bracket to be movable in the first direction; and
a third lighting bracket extending from the second lighting bracket, the third lighting bracket being connected to the light source.

7. The electrode sheet transporting apparatus as claimed in claim 6, wherein the light source is connected to the third lighting bracket, the light source being rotatable with respect to a second direction intersecting the first direction.

8. The electrode sheet transporting apparatus as claimed in claim 1, wherein the sensing member comprises:
a camera facing the lighting member in the first direction; and
a camera bracket supporting the camera.

9. The electrode sheet transporting apparatus as claimed in claim 8, wherein the camera bracket comprises:
a first camera bracket;
a second camera bracket connected to the first camera bracket, the second camera bracket being movable in the first direction; and
a third camera bracket extending from the second camera bracket, the third camera bracket being connected to the camera.

10. The electrode sheet transporting apparatus as claimed in claim 9, wherein the camera connected to the third camera bracket is rotatable with respect to a second direction intersecting the first direction.

11. The electrode sheet transporting apparatus as claimed in claim 1, further comprising a control member configured to control operation of the supply member based on information detected from the sensing member.

12. An electrode sheet transporting apparatus, comprising:
a first transporting conveyor having a first supply area receiving a first electrode sheet, the first transporting conveyor being configured to transport the first electrode sheet in a first direction;
a second transporting conveyor having a second supply area receiving a second electrode sheet, the second transporting conveyor being configured to transport the second electrode sheet in a direction opposite to the first direction;
a supply member configured to supply the first electrode sheet and the second electrode sheet to the first supply area and the second supply area, respectively;
a lighting member configured to radiate light to the first supply area and the second supply area; and
a sensing member facing the lighting member, the sensing member being configured to detect light reflected from the first electrode sheet on the first supply area and light reflected from the second electrode sheet on the second supply area.

13. The electrode sheet transporting apparatus as claimed in claim 12, wherein the first supply area and the second supply area are situated in a second direction intersecting the first direction.

14. The electrode sheet transporting apparatus as claimed in claim 13, wherein the supply member comprises:
a supply conveyor transporting the first electrode sheet and the second electrode sheet in the second direction; and
a conveying unit configured to convey the first electrode sheet and the second electrode sheet that are transported by the supply conveyor to the first supply area and the second supply area, respectively.

15. The electrode sheet transporting apparatus as claimed in claim 12, wherein the lighting member comprises:
a light source;
a first lighting bracket spaced apart from the light source;
a second lighting bracket connected to the first lighting bracket, the second lighting bracket being movable in the first direction; and
a third lighting bracket extending from the second lighting bracket, the third lighting bracket being connected to the light source.

16. The electrode sheet transporting apparatus as claimed in claim 13, wherein the lighting member comprises:
a first light source radiating light to the first supply area;
a second light source spaced apart from the first light source, the second light source radiating light to the second supply area;
a first support bracket supporting the first light source; and
a second support bracket spaced apart from the first support bracket, the second support bracket supporting the second light source.

17. The electrode sheet transporting apparatus as claimed in claim 16, wherein the first support bracket comprises:
a first bracket body;
a first connection bracket connected to the first bracket body; and
a first extension bracket extending from the first connection bracket, the first extension bracket being connected to the first light source, wherein the first light source is connected to the first extension bracket and movable in the second direction.

18. The electrode sheet transporting apparatus as claimed in claim 16, wherein the first support bracket comprises:
a first bracket body;
a first connection bracket connected to the first bracket body; and
a first extension bracket extending from the first connection bracket, the first extension bracket being connected to the first light source,
wherein the first extension bracket is connected to the first connection bracket and movable in a third direction intersecting the first direction and the second direction.

19. The electrode sheet transporting apparatus as claimed in claim 16, wherein the first support bracket comprises:
a first bracket body;
a first connection bracket connected to the first bracket body; and
a first extension bracket extending from the first connection bracket, the first extension bracket being connected to the first light source,
wherein the first extension bracket is connected to the first connection bracket, the first extension bracket being rotatable with respect to a third direction intersecting the first direction and the second direction.

20. The electrode sheet transporting apparatus as claimed in claim 13, wherein the sensing member comprises:
a camera between the first transporting conveyor and the second transporting conveyor; and
a camera bracket supporting the camera.
